(19) United States
(12) Patent Application Publication
(10) Pub. No.: US 2003/0043260 A1
(43) Pub. Date: Mar. 6, 2003

(54) Videophone answering device

(76) Inventors: Adrian Yap, Gaithersburg, MD (US); Michael Ficco, Silver Spring, MD (US); Robert Davis, Woodbine, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/041,857

(22) Filed: Jan. 9, 2002

Related U.S. Application Data
(60) Provisional application No. 60/315,859, filed on Aug. 29, 2001.

(51) Int. Cl. H04N 7/14

(52) U.S. Cl. 348/14.06; 348/14.01; 348/14.04

(57) ABSTRACT

A digital videophone answering device (DVAD) that utilizes the functionality of a device such as a set top box (STB) equipped with a digital video recorder (DVR). The system includes an exemplary DVAD operatively connected to or integral with an STB equipped with DVR. A memory within the DVR is used by the DVAD for storing a plurality of parameters and data associated with the DVAD; and a processor within the DVR controls DVAD functionality and display of parameters associated with DVAD.

### CROSS REFERENCE TO RELATED CASES

The present invention claims the benefit of priority under 35 U.S.C. §119(e) to U.S. Provisional Patent Application No. 60/315,859 to Adrian Yap et al., entitled “VIDEOPHONE ANSWERING DEVICE” filed on Aug. 29, 2001, the entire contents of which is incorporated by reference herein. Additionally, co-pending U.S. patent application Ser. No. 09/826,504 to Adrian Yap et al., entitled “DVR TELEPHONE ANSWERING DEVICE”, filed on Apr. 5, 2001 is hereby incorporated by reference in its entirety.

### BACKGROUND OF THE INVENTION

1. Field of the Invention

This invention generally relates to applications and features related to digital recording devices. More particularly, the present invention is directed to a system and/or apparatus composed of a digital videophone answering device (DVAD) connected to or integral with a set top box (STB) equipped with a digital video recorder (DVR).

2. Description of Related Art

Conventional communications systems typically include a receiver for receiving and processing transmitted waveforms. For example, in a satellite communications system, the receiver may include a small satellite dish connected by a cable to a set-top box (STB) or an integrated receiver-decoder (IRD), which are used as interchangeable terms in the art. The satellite dish is aimed toward the satellites, and the STB is connected to the user's television in a similar fashion to a conventional cable-TV decoder.

A micro-controller controls the overall operation of the STB, including the selection of parameters, the set-up and control of components, channel selection, viewer access to different programming packages, blocking certain channels, and many other functions. The compression and decompression of packetized video signals may be accomplished according to the Motion Picture Expert Group (MPEG) standards and the compression and decompression of audio signals may be accomplished according to the Motion Picture Expert Group (MPEG) standards, DOLBY DIGITAL (or AC-3) standards, DTS or other known standards. The conventional STB also typically includes video and audio decoders in order to decompress the received compressed video and audio. The STB may output video and audio data to a number of destinations, including audio and video decoders, ports, memories, and interface devices, such as a digital VHS (DVHS) interface. The STB may send the same audio and video data to different destinations.

Recently, due to the advances in digital technology and with a goal of creating greater personalized television for viewers, the STB has become embodied as part of a digital VCR (DVCR) an/or digital VHS (DVHS) receiver for example, in the continuing development of digital video recording devices. These devices incorporate a host of both traditional and powerful new features. For example, these features may include high quality digital A/V, the ability to pause/rewind live video and/or audio programs as they are broadcast, multi-speed fast forward and fast rewind, instant replay, slow motion and frame by frame advance. Additionally, the viewer may have access to, and have the ability to manipulate or develop an electronic program guide of listings.

Such digital video recording devices allow sports fans and movie buffs alike to have full control of live television programs and sporting events in full digital-quality. Viewers may also be able to create customized programming by searching for, and recording, programs that match their preferences by actor, director, keyword or any combination of content searches. Combined with the wide variety of program selections, viewers may find exactly what they are looking for and even create their own “TV channels” based on their favorite programming.

The electronic program guides generally may be displayed as a menu on a screen of a TV for example. Operation of push buttons or keys of a remote control may display a series of menu screens having an array of cells corresponding to particular programming events, channels, TV programs, etc. The viewer may scroll through the cells to choose a particular program, pull up another sub menu to find out more information on a particular program, or pull up a sub menu with additional options.

Most everyone is acquainted with the conventional telephone answering device (TAD). Typically the device is hooked up to a telephone and by means of a magnetic recording medium, records oral messages received from a caller after sending an outgoing message beforehand. However, the conventional TAD is limited as to its storage capacity and is cumbersome to the user when retrieving messages, since often the user must listen to all messages stored thereon and then copy the messages down to obtain a hard copy.

In an effort to overcome some of these problems, digital telephone answering devices (DTAD) have been developed which provide much greater functionality and flexibility to the user than the conventional magnetic tape recording TADs. For example, voice mail DTADs such as that disclosed in U.S. Pat. No. 5,400,393 to Knuth et al. dynamically allocates RAM to store incoming and outgoing messages in particular “mailboxes”, converting analog voice received over a telephone line into digital form.

U.S. Pat. No. 5,343,516 to Callele et al. describe interfaces that can be used to connect a computer to a telecommunications system in order to perform functions that typically might be performed by a DTAD (caller-ID, repeat dial, automatic call back, etc.). Callele et al. also describe the ability to display caller-ID information on a TV screen for example.

U.S. Pat. No. 5,917,892 to Lee describes a recorded telephone message/number identifying apparatus that uses a TV screen in order to display the time at which a caller called with caller-ID (phone number only), and whether or not a voice message was saved. The user may then select a desired recording to hear, the voice message being played back on the TV speaker for example. And U.S. Pat. No. 6,141,058 to Lagoni et al. describe a television receiver that includes telephone network interface circuitry enabling the receiver to receive and process caller-ID signals for display, with messages from priority callers designated to interrupt a viewer's broadcast being displayed at the discretion of the viewer.

Video conferencing or videophone technology is also blossoming. Currently, audio and video (visual) conferencing capabilities are implemented as computer based systems, such as in personal computers (“PCs”), as stand-alone, “roll about” room systems, and as videophones.

These systems typically require significant hardware, software and programming, plus require significant communications network connections, for example, multiple channels of an Integrated Services Digital Network (“ISDN”) connection or a T1/E1 connection.

For example, systems for audio and video conferencing typically require dedicated hardware at significant expense, in the tens of thousands of dollars, utilizing dedicated video cameras, television displays, microphone systems, and the additional video conferencing equipment. Such systems may also require as many as six (or more) contiguous ISDN B channels (or T1/E1 DSOs), each operating at 64 kbps (kilobits per second). PC based systems also typically require, at a minimum, ISDN basic rate interface service, consisting of 2 ISDN B channels (each operating at 64 kbps) plus one D channel (operating at 16 kbps). Such communication network capability is also expensive and potentially unnecessary, particularly when the additional channels are not in continuous use.

Conventional videophone equipment is also limited to communication with similar equipment at the far end (remote location). For example, videophone systems which utilize typical telephone systems (“POTS”—plain old telephone service) transmit information in analog form, for example, as trellis code modulated data, at V.34 and V.34 bis rates (e.g., highest rates of approximately 28.8 to 33 kbps). Such POTS-based videophone systems would not be compatible with ISDN audio/visual conferencing and telephony systems which transmit information in digital form, such as utilizing Q.931 message signaling, Q.921 LAPD datalink, and Q.910 physical interface digital protocols, with data rates of 128 kbps (two B channels) or more with additional channels or DSOs.

Moreover, it is not heretofore known that videophone technology has evolved to where digital videophone answering systems have been developed or are even available, given the above constraints. Although digital video recording devices and the DTADs described above are known, the combination of these known arts with videophone technology has never been embodied in a digital videophone answering device (DVAD) that is operatively connected to, or integral with, a set top box (STB) equipped with a digital video recorder (DVR). Accordingly, there is a need for a DVAD that can take advantage of the practically unlimited storage capacity and plurality of menu driven functions and features offered by a STB equipped with DVR, providing a videophone answering device with substantial functionality and flexibility to meet the world's future communication needs.

### SUMMARY OF THE INVENTION

The present invention is directed to a digital videophone answering device (DVAD) that utilizes the functionality of a device such as a set top box (STB) equipped with a digital video recorder (DVR). The system includes an exemplary DVAD operatively connected to or integral with an STB equipped with DVR. A memory within the DVR is used by the DVAD for storing a plurality of parameters and data associated with the DVAD; and a microprocessor within the DVR controls DVAD functionality and display of parameters associated with the DVAD.

Control is based on receiving user commands to access the memory and to display at least a selected one of DVAD-associated parameters for review and/or manipulation by the viewer on a display device operatively connected to the STB-equipped with DVR. A suitable interface such as a remote control may be used in order to transmit a command to display desired DVAD parameter(s), features or associated data.

Parameters, features, functions and displays related to the operation of the integrated STB-equipped with DVR and videophone answering device (DVAD) include, but are not limited to: menu-based means to record multiple versions of caller-specific multimedia greetings for outbound calls; menu selectable features for inbound calls allowing users to enable call blocking or acceptance based on criteria selected by user, features to set fixed or variable record time and audio/video digital compression quality; menu selectable recording management functions enabling users to delete, archive, backup, cut-truncate-paste messages; call notification routing features to notify designated phone(s) when an incoming call is detected; a security function that records to storage media and/or streams A/V data to on-site and/or remote devices, and other attributes associated with the functionality and operation of the DVAD.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, wherein like elements are represented by like reference numerals, which are given by way of illustration only and thus are not limitative of the present invention and wherein:

FIG. 1 is an exemplary arrangement of a set-top box (STB) and DVAD within a direct broadcast satellite or digital video broadcast system in accordance with the invention;

FIG. 2 illustrates a general data flow in a direct broadcast satellite or digital video broadcast system in accordance with the invention;

FIG. 3 is a block diagram of an exemplary architecture of the STB-equipped with DVR and DVAD;

FIG. 4 is a block diagram showing an exemplary construction of the graphics accelerator according to the invention;

FIG. 5 illustrates a partial block diagram of FIG. 3 to show the components associated with the DVAD portion of the STB equipped with DVR;

FIG. 6 is a flow diagram showing data flow for recording a program, broadcast or event for later playback in accordance with an exemplary embodiment of the invention;

FIGS. 7A and 7B illustrate exemplary answer and record modes for the DVAD in accordance with the invention;

FIG. 8 illustrates a general playback flow diagram for a stored audiovisual (A/V) message in accordance with an exemplary embodiment of the invention;

FIG. 9 illustrates a partial block diagram of FIG. 3 to show an exemplary communication path between a remote control and a host processor of the STB equipped with DVR and DVAD;

FIG. 10 illustrates the data flow to display a parameter or data of the DVAD using the STB equipped with DVR circuitry;

FIG. 11 illustrates an exemplary DVAD main menu screen according to the invention;

FIG. 12 illustrates a submenu associated with message management in accordance with the invention.

FIG. 13 illustrates a submenu associated with a caller directory in accordance with the invention;

FIG. 14 illustrates how external data files are sent to a remote destination in accordance with the “send e-file” cell 558 of FIG. 12;

FIG. 15 illustrates a submenu of an exemplary private box arrangement requiring password entry in accordance with the invention;

FIG. 16 illustrates an exemplary pop-up menu that is displayed when the virtual address book

FIG. 17 illustrates a submenu to customize an A/V greeting for incoming videophone messages; and

FIG. 18 illustrates an alternate embodiment of a DVAD connected to an external mass storage device and the host processor of the STB equipped with DVR in accordance with the invention.

### DETAILED DESCRIPTION

The present invention provides a digital videophone answering device (DVAD) that is integral with a set top box (STB) equipped with DVR. The system integrates a comprehensive management system (or selected components thereof to enable users to record audio and video (A/V) greetings for outbound calls, and to record inbound videophone or even conventional voice message calls to a storage media. The information recorded contains audio, video, A/V, text, etc.. The present invention takes advantage of a virtually unlimited storage capacity and plurality of menu driven functions offered by the STB-equipped with DVR.

The present invention provides the ability to maintain a DVAD that also includes digital telephone answering device functionality to handle conventional, voice messages on a STB-equipped with DVR, by utilizing the audio and video features of the STB-equipped with DVR and associated display device(s) connected thereto. The DVAD utilizes the same Ethernet, ISDN, T1/E1 and/or telephone line as the STB-equipped with DVR, and may use memories that are integrated within the DVR architecture of the STB and/or an external mass storage device or memory.

Memory devices within the DVR are used by the DVAD for storing a plurality of parameters and data associated with the DVAD. A microprocessor within the DVR controls DVAD functionality and display of parameters associated with the DVAD. Control is based on receiving user commands to access the memory and to display at least a selected one of the DVAD associated parameters for review and/or manipulation by the viewer on a display device operatively connected to the STB-equipped with DVR. A suitable interface such as a remote control may be used in order to transmit a command to display desired DVAD parameter(s) or associated data.

A DVAD main menu or guide may be depicted on a TV or other display device, effected via a user command interface to the DVR, such as by operation of a remote control device to send commands to a processor within the DVR, for example, and manipulated via a graphical user interface (GUI) controlled by the processor.

Parameters, data or features related to the DVAD functionality or operability may be accessed, displayed for viewing and/or manipulated by the user or viewer. These features may include a main DVAD menu listing of messages received which include a menu display providing the identity of the caller with number and a short text synopsis of the corresponding stored A/V, or audio-only message adjacent thereto; a submenu displaying a directory of caller data that may be accessed by a user, said directory for adding, deleting or searching desired caller information.

Additional features include a means to enable the user to choose between a A/V greeting of a caller, or, if the caller has no videophone, enables a pre-recorded video or still image of the caller to be displayed. In another aspect, the DVR is configured to record and playback received A/V messages to or from the mass storage device in a substantially simultaneous fashion, by playing an outgoing A/V message, then immediately recording an inbound caller's A/V message on the mass storage device. The outgoing or outbound A/V message is temporarily displayed as a freeze-frame video image while the inbound message is being received and recorded.

Further features of the present invention enable a user to display a listing of all messages received with a given time frame, such as the current day, week or a specified day or week in the past. Each listing includes at least one of the name of the caller, videophone number, length of message including beginning header text of the message. Moreover, the user has an option to automatically call back a caller by selecting the caller on the display with a specified key. The user may also display a virtual phone book listing all phone numbers of frequent callers and numbers that are frequently called by the user. The virtual phone book includes URLs for streaming audio and/or video, so as to handle a voice-over IP message or call originating from a browser instead of a videophone. These and other attributes associated with the functionality and operation of the DVAD are envisioned by the present invention, as will be explained in much detail below.

Therefore, the present invention provides a DVAD that has enhanced functionality as compared to conventional telephone answering devices, since it utilizes existing hardware and software architecture of a STB equipped with DVR to which it is operatively connected. As will be explained in further detail later in this disclosure, the DVAD is capable of storing an enormous amount of telephone and videophone messages. Moreover, various menu screens associated with DVAD features, data or parameters may be displayed and manipulated by the user operating a simple command user interface such as a remote control, which communicates with a suitable graphical user interface (GUI) in the STB-equipped with DVR, providing even greater flexibility.

However, before describing the above features in greater detail, the inventors initially offer a general discussion on a set-top box (STB) equipped with a digital video recorder (DVR) within a direct broadcast satellite or digital video broadcast (DVB) system. Additionally, the basic architecture and operation of the STB-equipped with DVR is explained in order to provide a context for the DVAD that is operatively attached thereto, such that a viewer can monitor various functions or parameters of the DVAD on a display device operatively connected thereto.

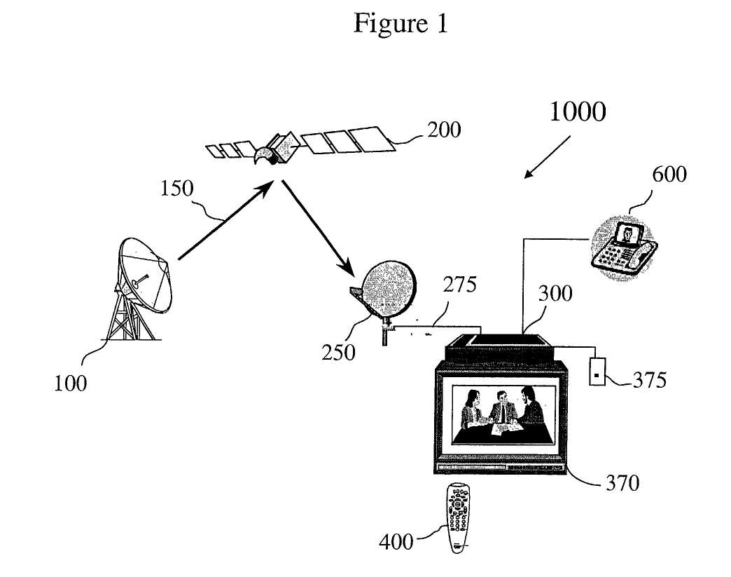

FIG. 1 is an exemplary arrangement of a STB 300 equipped with a DVR and DVAD within a direct broadcast satellite or digital video broadcast (DVB) system, in accordance with the present invention. In the exemplary embodiment of FIG. 1, the system 1000 may comprise a transmit antenna station (hereinafter referred to as uplink facility 100 for clarity), satellite 200, receive antenna 250, STB 300 equipped with DVR (within STB 300) and DVAD 600 operatively attached thereto.

The transmit antenna station may be a DIRECTV satellite uplink facility, for example, or any other earth station as described above and which is well known in the art. The bitstream or airlink 150 is a suitable content signal such as a digital audio and video television data signal (A/V signal), the medium is a satellite 200, and the receive antenna 250 is preferably an outdoor unit (ODU). As illustrated in FIG. 1, the ODU is connected to STB 300 via coaxial cable 275.

In this exemplary embodiment, the DVR of the present invention is included in, or subsumed within STB 300. However, the invention is applicable to any STB having a multiple-processor configuration. STB 300 may further be connected to a display 370, such as a standard definition television, a high definition television or a PC monitor and also may be connected to a telephone line 375. The DVR-equipped STB 300 may be controlled via a remote control 400 as is well known in art, using known RF and/or IR transmission and reception techniques.

The user command interface in the present invention however is not limited to a remote control device. Alternatively, any of function buttons residing on the STB and/or DVAD structure itself, a keyboard operatively connected thereto and/or connected to a PC that is in communication with the STB, USB serial ports, voice-activation software devices within or operatively connected to the STB, or command and/or instructions by remote call-in using DTMF (Dual Tone Multifrequency) tones for example, may be substituted as the user command interface to the STB or DVR, and/or to control designated functions of the DVAD connected thereto, as will be explained in detail hereinafter.

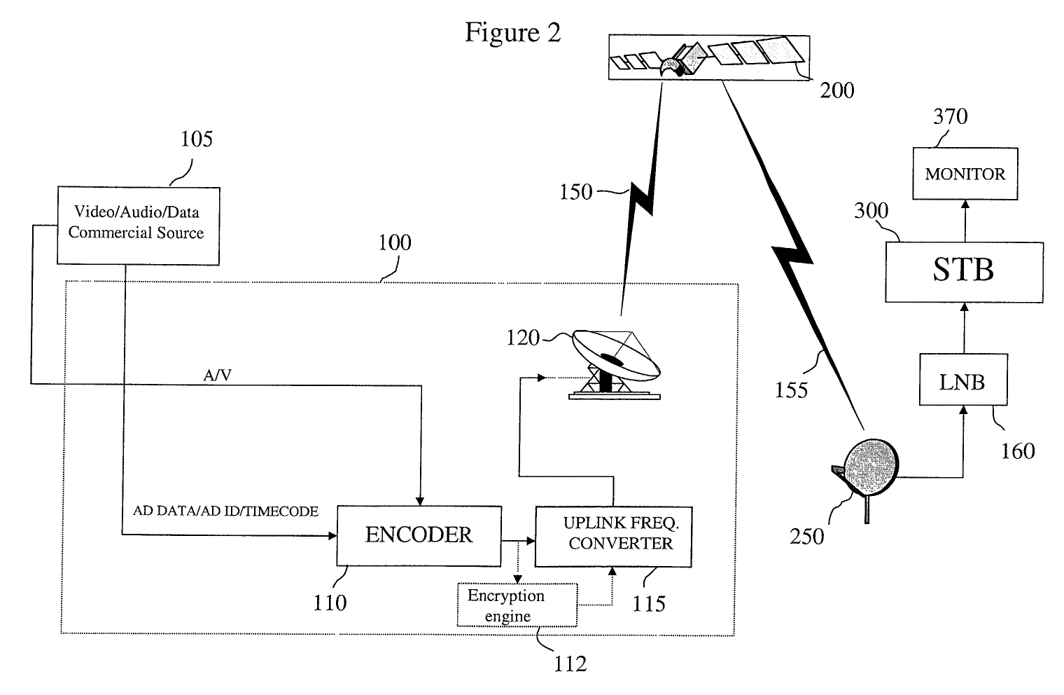

FIG. 2 provides a general understanding of the overall system organization, by illustrating the general data flow in a direct broadcast satellite or digital video broadcast system. In operation, the uplink facility 100 can receive video and audio programming from a number of sources, including satellites, terrestrial fiber optics, cable, or tape. Preferably, the received programming signals, along with data signals such as electronic scheduling data and conditional access data, are sent from some commercial source 105 to a video/audio/data encoding system 110 within uplink facility 100. Here, they are digitally encoded and multiplexed into a packetized data stream using a number of conventional algorithms, including convolution error correction and compression, for example.

In a conventional manner, the encoded data stream is modulated and sent through an uplink frequency converter 115 that converts the modulated encoded data stream to a frequency band suitable for reception by the satellite 200. Preferably, the satellite frequency is K-band such as in the Ku-band; however the frequency may be in the Ka band as well. The modulated, encoded data stream is then routed from the uplink frequency converter 115 to an uplink satellite antenna/dish 120, where it is broadcast toward the satellite 200 over the airlink 150. The encoded data stream may be encrypted and encoded, by a suitable encryption engine 112 (dotted lines), or not encrypted and encoded.

The satellite 200 receives the modulated, encoded Ku-band data stream via airlink 150, and re-broadcasts it downward via downlink 155 toward an area on earth that includes the various receiver stations (STB 300, for example). In this embodiment, the satellite dish (ODU 250) of STB 300 shifts the Ku-band signal down to an L-band signal which is transmitted via a LNB downconverter 160 to STB 300, for eventual reproduction on display monitor 370.

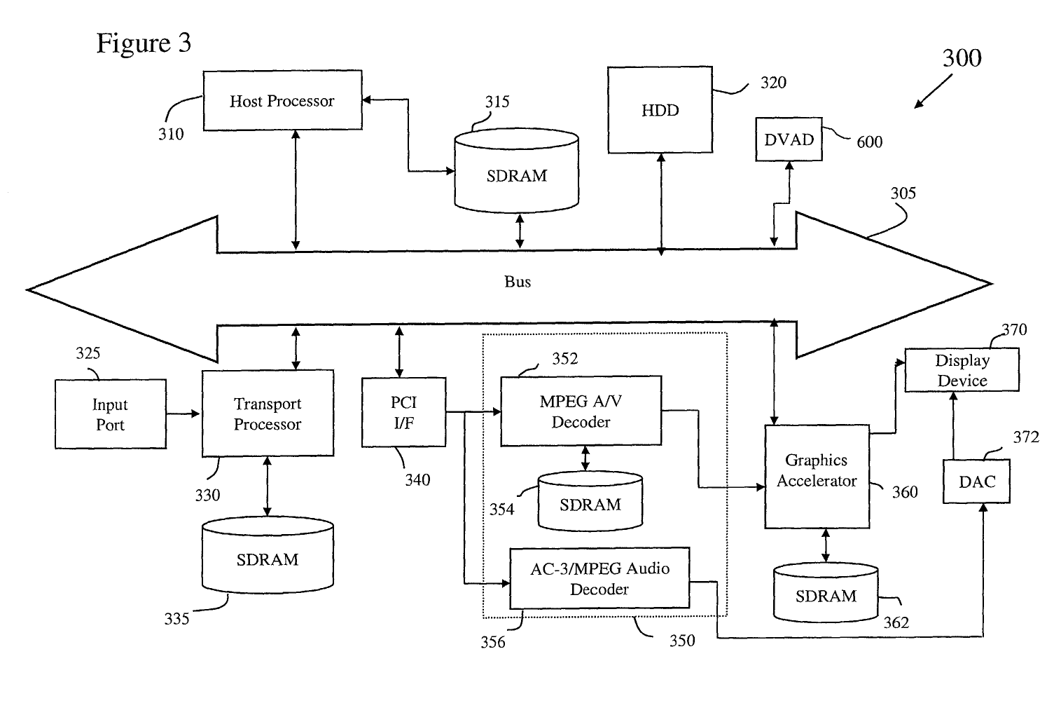

Front-end circuitry, which may or may not be part of STB 300, receives the L-band RF signals from the LNB downconverter 160 and converts them back into the original digital data stream. The front-end circuitry may include a tuner. Circuitry (shown and explained in more detail in FIG. 3) receives the original data streams via an input port and performs video/audio processing operations such as de-multiplexing and decompression. The overall operation of STB 300, including the selection of parameters, the set-up and control of components, channel selection, a user's access to different program packages, and many other functions, both real time and non-real time, are controlled by one or more processors within STB 300, as will be further explained below.

FIG. 3 illustrates an exemplary architecture of the STB 300 with DVAD 600 connected thereto in accordance with the present invention. The STB 300 utilizes a bus 305 to interconnect various components and to provide a pathway for data and control signals.

FIG. 3 illustrates a host processor 310, a memory device 315 (in an exemplary configuration embodied as an SDRAM 315) a hard disc drive (HDD) 320 and a DVAD 600 connected to the bus 305. In this embodiment, the host processor 310 may also have a direct connection to SDRAM 315 as shown in FIG. 3 (i.e., such that SDRAM 315 is associated as the memory for host processor 310). Although memory device 315 is described as SDRAM 315 hereinafter in the present application, memory devices of EDO RAM (extended data output DRAM), BEDO RAM (Burst EDO RAM), RLDRAM by Rambus, Inc., SLDRAM by the SyncLink Consortium, VRAM (video RAM), or any other known or developing memory that is writeable may be sufficient as memory device 315.

As further shown in FIG. 3, a transport processor 330 and PCI I/F 340 (peripheral component interconnect interface) are connected to the bus 305. The transport processor 330 also has a connection to input port 325 and SDRAM 335. SDRAM 335 has the same attributes as SDRAM 315 and may be replaced with any of the other above-noted alternative memory devices. Furthermore, the PCI I/F 340 is connected to a decoder 350. The decoder 350 is connected to a video encoder 360. The output of video encoder 360 is in turn sent to a display device 370. Decoder 350 may include both an MPEG A/V decoder 352 and an AC-3/MPEG audio decoder 356, the output of the latter being sent to display device 370 after conversion in a digital-to-analog converter (DAC) 372.

The host processor 310 may be constructed with conventional microprocessors such as the currently available PENTIUM processors from Intel. Host processor 310 performs non real-time functions in the STB 300 and DVAD 600, such as control of attached components, and control of graphical-user interface (GUI) and browser functions. A browser is a software engine that presents the interface to, and interacts with, a user of the STB 300. The browser is responsible for formatting and displaying user-interface components and pictures. Typically, the user interface is displayed as a GUI.

Browsers are often controlled and commanded by the standard HTML language, which is used to position and format the GUI. Additionally, or in the alternative, any decisions and control flow of the GUI that requires more detailed user interaction may be implemented using JavaScript™. Both of these languages may be customized or adapted for the specific details of a given STB 300 implementation, and images may be displayed in the browser using well known JPG, GIF and other standardized compression schemes. It is noted that other non-standardized languages and compression schemes may be used for the browser and GUI, such as XML, “home-brew” languages or other known non-standardized languages and schemes.

In addition to performing the aforementioned non-real time functions, host processor 310 may contain a voice recognition engine 625, which may be embodied as any of an algorithm, software or program that is well known in the art to be used to convert digital voice into digital text. For example, a suitable algorithm may be similar to well known software developed in order to translate voice data into a visual text display for the deaf, closed caption systems, reverse text-to-speech (TTS) synthesis processing systems, and automatic speech recognition (ASR) engines such as is described in U.S. Pat. No. 6,138,095 to Gupta et al. entitled “Speech Recognition”.

HDD 320 is actually a specific example of a mass storage device. In other words, the HDD 320 may be replaced with other mass storage devices as is generally known in the art, such as known magnetic and/or optical storage devices, (i.e., embodied as RAM, a recordable CD, a flash card, memory stick, etc.). In an exemplary configuration, HDD 320 may have a capacity of at least about as great as any current or future mass storage technology permits.

HDD 320 thus provides enormous storage capacity for the storing of videophone/telephone messages and associated caller-ID information that may be stored in a suitable directory database of names. For example, assuming only one (1) Gbyte of the HDD 320's memory is allocated for DVAD 600 operation, this translates (at 32 kbits/sec for MPEG-1 audio and about 60 kbits/sec for MPEG-2 video, which would typically be the lowest rates) to in excess of 22 hours of recording time available for DVAD 600 recording operations. However, the present invention is not limited by this capacity, only to that capacity available in current and future bulk storage technologies and compression efficiency. Moreover, with the amount of memory dedicated for DVAD 600 operations, it is conceivable that enormous videophone/telephone directory-sized databases can be stored and managed by a user without significantly burdening the overall processing capability of STB 300.

The bus 305 may be implemented with conventional bus architectures such as a peripheral component interconnect (PCI) bus that is standard in many computer architectures. Alternative bus architectures such as VMEBUS from Motorola, NUBUS, address data bus, RAM bus, DDR (double data rate) bus, etc., could of course be utilized to implement bus 305.

The transport processor 330 performs real-time functions and operations such as control of the A/V data flow, conditional access, program guide control, etc., and may be constructed with an ASIC (application specific integrated circuit) that contains, for example, a general purpose R3000A MIPS RISC core, with sufficient on-chip instruction cache and data cache memory. Furthermore, the transport processor 330 may integrate system peripherals such as interrupt, timer, and memory controllers on-chip, including ROM, SDRAM, DMA controllers; a packet processor, crypto-logic, PCI compliant PC port, and parallel inputs and outputs. The implementation shown in FIG. 3 actually shows the SDRAM 335 as being separate from the transport processor 330, it being understood that the SDRAM 335 may be dispensed with altogether or consolidated with SDRAM 315. In other words, the SDRAMs 315 and 335 need not be separate devices and can be consolidated into a single SDRAM or other memory device.

Input port 325 receives audiovisual bitstreams that may include, for example, MPEG-1 and MPEG-2 video bitstreams, MPEG-1 layer II audio bitstreams and DOLBY DIGITAL (AC-3) audio bitstreams. Exemplary A/V bitrates may range from about 60 Kbps to 15 Mbps for MPEG video, from about 56-384 Kbps for MPEG audio, and between about 32-640 Kbps for AC-3 audio. The single-stream maximum bitrate for STB 300 may correspond to the maximum bitrate of the input programming, for example 16 Mbps or 2 MBps, which corresponds to the maximum MPEG-2 video bitrate of 15 Mbps, maximum MPEG-1 Layer-2 audio bitrate of 384 kbps, and maximum AC-3 bitrate of 640 kbps.

Any audio or video formats known to one of ordinary skill in the art could be utilized. Although FIG. 3 has been described in conjunction with digital television, the signal supplied could be any type of television signal, any type of audio or video data, including of course analog voice data over a telephone line, or any downloadable digital information. Of course, various other audiovisual bitstream formats and encoding techniques may be utilized in recording. For example, STB 300 may record an AC-3 bitstream, if AC-3 broadcast is present, along with MPEG-1 digital audio. Still further, the received audiovisual data may be encrypted and encoded or not encrypted and encoded. If the audiovisual data input via the input port 325 to the transport processor 330 is encrypted, then the transport processor 330 may perform decryption. Moreover, the host processor 310 may perform the decryption instead.

Alternatively, the host processor 310 and transport processor 330 may be integrated or otherwise replaced with a single processor. As mentioned above, the SDRAMs (315 and 335) may be consolidated or replaced with a single SDRAM or single memory device.

The PCI I/F 340 may be constructed with an ASIC that controls data reads from memory. Audiovisual (A/V) data may be sent to the host processor 310's memory (SDRAM 315) while simultaneously being sent to an MPEG A/V decoder 352, as further discussed below.

Decoder 350 may be constructed as shown in FIG. 3 by including the MPEG A/V decoder 352 connected to the PCI I/F 340, as well as an AC-3/MPEG audio decoder 356 that are also connected to the PCI I/F 340. In this way, decoders 352 and 356 can separately decode the video and audio bitstreams from the PCI I/F 340, respectively. Alternatively, a consolidated decoder may be utilized that decodes both video and audio bitstreams together. The encoding techniques are not limited to MPEG and AC-3, of course, and can include any known or future developed encoding technique. In a corresponding manner, the decoder 350 could be constructed to process the selected encoding technique(s) utilized by the particular implementation desired.

In order to more efficiently decode the MPEG bitstream, the MPEG A/V decoder 352 may also include a memory device such as SDRAM 354 connected thereto. This SDRAM 354 may be eliminated, consolidated with decoder 352 or consolidated with the other SDRAMs 315 and/or 335. SDRAM 354 has the same attributes as SDRAM 315 and 335, and may be replaced with any of the other above-noted alternative memory devices.

A graphics accelerator (GA) 360 includes processing circuitry for performing graphics processing of a decoded input video stream, and encoding circuitry for encoding and converting the processed video to analog prior to outputting it to display device 370. GA 360 also includes a memory interface that communicates with an SDRAM 362 in order to direct the incoming video bit stream to a specific storage location in SDRAM 362, and also selects the frames and frame order for display.

Display device 370 may be an analog or digital output device capable of handling a digital, decoded output from the GA 360. If analog output device(s) are desired, to listen to the output of the AC-3/MPEG audio decoder 356, a digital-to-analog converter (DAC) 372 is connected to the decoder 350. The output from DAC 372 is an analog sound output to display device 370, which may be a conventional television, computer monitor screen, portable display device or other display devices that are known and used in the art. If the output of the AC-3/MPEG audio decoder 356 is to be decoded by an external audio component, a digital audio output interface (not shown) may be included between the AC-3/MPEG audio decoder 356 and display device 370. The interface may be a standard interface known in the art such as a SPDIF audio output interface, for example, and may be used with, or in place of DAC 372, depending on whether the output devices are analog and/or digital display devices.

The video output from GA 360 and/or audio output from audio decoder 356 or DAC 372 does not necessarily have to be sent to display device 370. Alternatively, encoded A/V data may be output to external devices or systems operatively connected to the STB 300, such an off-broadcast system, cable TV (CATV) system or other known systems that can reproduce the encoded audio and/or video signals for reproduction and/or display. This may also include a PC that can play video or audio files containing the encoded A/V data sent from the STB 300, for example. In such an embodiment, A/V, text and/or voice files could be sent from the STB 300 to the PC in the form of an e-mail message with the A/V, text or sound file as an attachment thereto, as will be explained in more detail hereinafter.

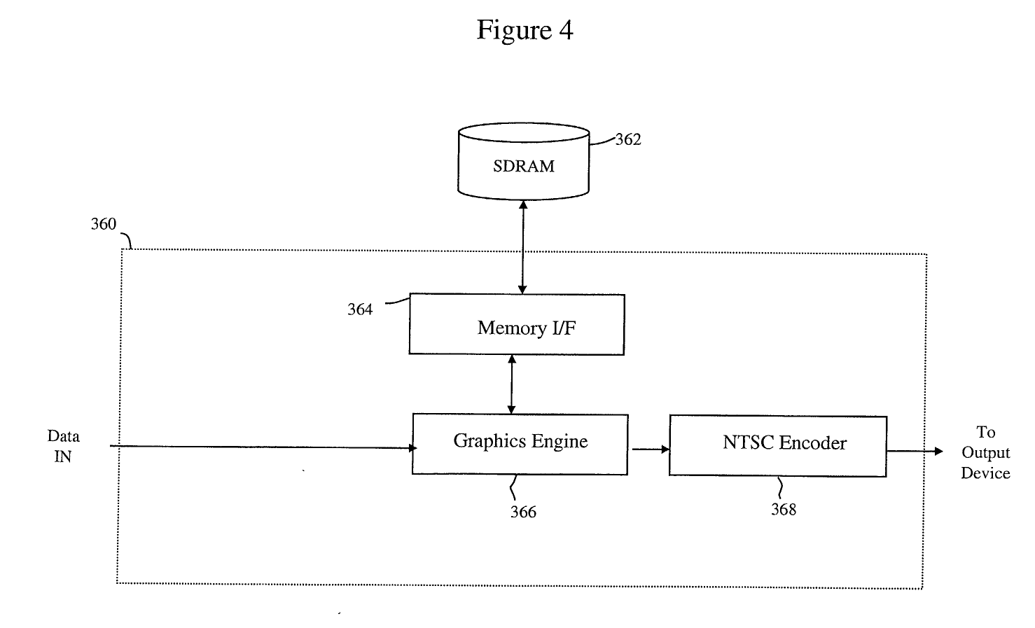

FIG. 4 is a block diagram showing an exemplary construction of the graphics accelerator according to the invention. The GA 360 preferably is a graphics chip that includes a memory interface (I/F) 364 to SDRAM 362, a graphics engine 366 and a TV encoder 368. The memory interface 364 and TV encoder 368 are shown embedded in GA 360; however, these components may be separate or external from GA 360.

Memory I/F 364 is preferably an industry standard SDRAM interface, but may also be one of a PCI bus, RAM bus, DDR (double data rate) and EDO RAM (Extended Data Output DRAM) interface used in the art. Memory I/F 364 controls access to a display memory portion in SDRAM 362. In particular, memory interface 364 informs the incoming video data where it is to be stored in SDRAM 362. Additionally, memory I/F 364 selects the decoded data (which are being stored in SDRAM 362) that are going to be displayed on display device 370.

Graphics engine 366 may preferably be a 64-bit DRAM based XVGA controller with hardware accelerated BitBLT (bit block transfer), video playback and video capture to a frame buffer (SDRAM 362 for example). However, graphics engine 366 should not be limited to this specific implementation. In other words, the graphic engine 366 may be implemented with other controller technologies.

TV encoder 368 is preferably an NTSC encoder that encodes, or converts the digital video output from graphics engine 366 into a coded analog signal for display. Regarding the specifications of the NTSC (National Television Standards Committee) encoder 368, the NTSC is responsible for setting television and video standards in the United States. The NTSC standard for television defines a composite video signal with a refresh rate of 60 half-frames (interlaced) per second. Each frame contains 525 lines and can contain 16 million different colors.

In Europe and the rest of the world, the dominant television standards are PAL (Phase Alternating Line) and SECAM (Sequential Color with Memory). Whereas NTSC delivers 525 lines of resolution at 60 half-frames per second, PAL delivers 625 lines at 50 half-frames per second. Many video adapters or encoders that enable computer monitors to be used as television screens support both NTSC and PAL signals. The SECAM standard was introduced in the early 1960's and implemented in France. SECAM uses the same bandwidth as PAL but transmits the color information sequentially. SECAM runs on 625 lines/frame.

Thus, although use of an NTSC encoder for TV encoder 368 is envisioned to encode the processed video for display on display device 370, the present invention is not limited to this standard encoder. PAL and SECAM encoders may also be utilized. Further, developing HDTV encoders may also be viable to encode the processed video for display on a HDTV, for example.

SDRAM 362 is similar in its construction to SDRAM 315. SDRAM 362 provides the extra frame buffers (sufficient memory, preferably at least 2 Mbyte or greater) necessary to temporarily store the decoded data prior to being output for display on display device 370.

As seen in FIG. 4, the decoded video data is input into graphics engine 366, whereby it is subject to graphics processing to prepare the data for system to display transfer. Memory interface 364 instructs SDRAM 362 to output the selected data for playback to graphics engine 366. Thereafter, the data for display can be encoded and converted to analog at TV encoder 368 before being sent to display device 370.

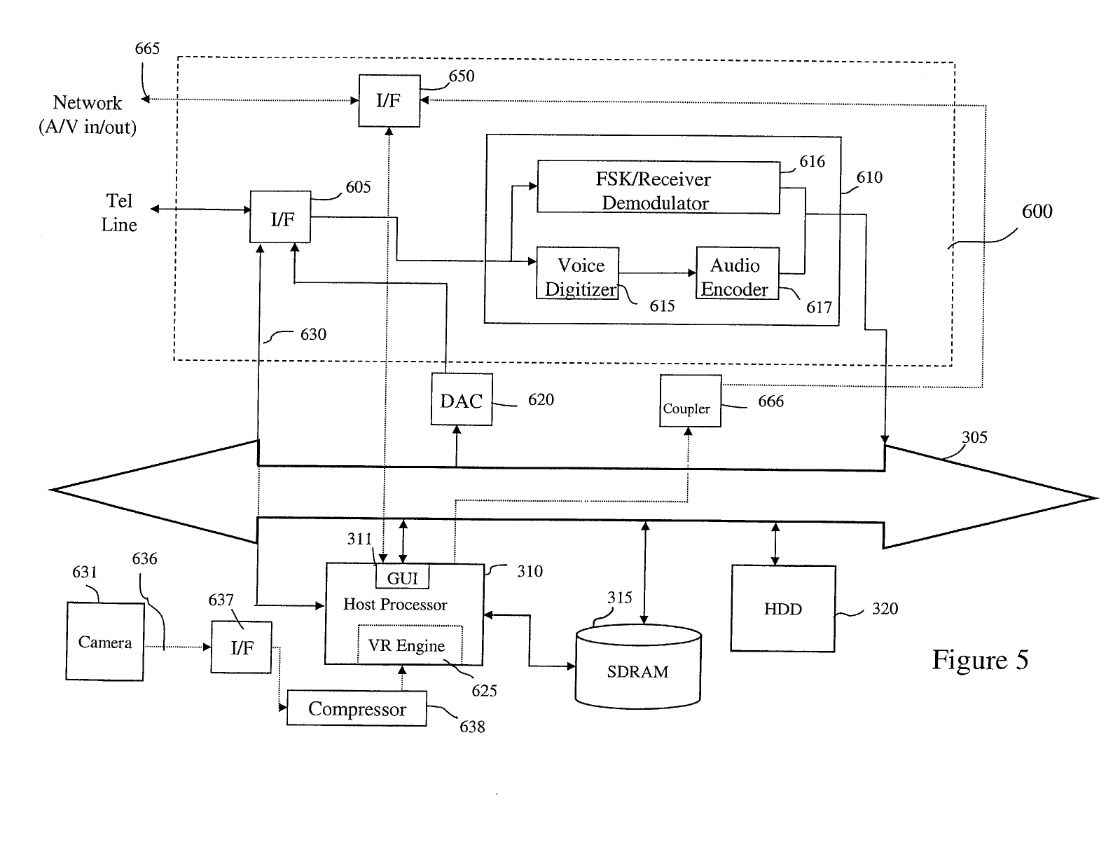

Up to this point, the overall architecture of the STB with DVR has been illustrated and briefly described in connection with the present invention. FIG. 5 illustrates a partial block diagram of FIG. 3 to show the components associated with the DVAD 600 portion of the STB equipped with DVR and DVAD. Data flow paths related to the recording and displaying of A/V videophone messages are indicated by the dotted lines for convenience in FIG. 5.

Initially, the inventors submit that STB 300 without modification can support almost all operations and functionality envisioned in DVAD 600. What is needed are essentially suitable interfaces between an external medium, such as a network and STB 300, and between a video camera and the STB 300. Circuitry of the DVAD 600 illustrated in FIG. 5 is physically located within a separate DVAD body (not shown) that may include a handset and local function keys thereon that are similar to known videophone structures. Thus, a detailed description thereof is omitted. Additionally, although many of the features of the DVAD 600 described in accordance with the invention are illustrated by a user sending commands to a microprocessor via a user interface, commands or functions may of course be initiated locally be manipulation of keys or button of a keyboard on the DVAD 600.

In FIG. 5, DVAD 600 includes circuitry to handle both videophone messaging operations as well as conventional voice message and answering operations. DVAD 600 includes an A/V network interface 650 couple able to a communications channel 665 communicating with a suitable network. Channel 665 may receive an incoming radio frequency (RF) video or audio/video (A/V) signal representing an incoming videophone message that is to be received by DVAD 600. For videophone operations, this incoming signal (A/V IN) will almost always be a compressed, digitally coded A/V signal. Thus, the signal can be directed from interface 650 directly to the STB 300 at host processor 310 for processing and storage in SDRAM 315/HDD 320. If the signal has encryption, decryption could be initially performed by transport processor 330, or by decryption algorithms within host processor 310 or accessed from SDRAM 315. Interface 650 may include format conversion circuitry if necessary to convert the incoming signal to a signal suitable for processing by host processor 310.

The input mechanism for this signal can be via USB/Ethernet port, satellite receiver, etc., but is not limited to these mechanisms. Additionally, if the incoming signal is analog, DVAD 600 may include an analog-to-digital (A/D) converter and an encoder (not shown for clarity). The encoder provides encoding of received analog A/V signals representing the incoming videophone caller or message. The encoding provides a digitally coded A/V signal that is to be sent to host processor 310 for storage and processing. In the present invention, the A/D and encoder could be embodied as part of network interface 650.

Additionally, DVAD 600 includes a camera 631 to create an outgoing message (OGM) to play to callers. This analog message can be converted and compressed into a digitally coded compressed A/V signal for transmission, via interface 650 and channel 665 over a suitable communications channel 665 to a network or to the caller, to be received by one or more video displays (not shown) of the caller.

A suitable graphical user interface (GUI) 311 that is controlled by host processor 310 is utilized for reception of a control signal transmitted by a remote control 400. These could be a plurality of control signals, such as a request to display a videophone message, a request to edit the outgoing videophone message, and other control signals such as alerting signals of incoming telephony or audio and video calls from an external videophone caller.

As noted above, the video camera 631 generates the outgoing message to callers (outgoing in the sense of being transmitted from the DVAD 600 to another location), and may also include a microphone for generation of the outgoing audio portion of outgoing videophone message, and may be implemented utilizing an ordinary video camera or camcorder in the preferred embodiment.

A camera interface 637 is utilized to convert (analog to uncompressed digital) the outgoing videophone message from the video camera 631. The digitized, but uncompressed A/V stream is compressed by a suitable compressor 638 and fed to host processor 310. Host processor 310 is operatively coupled to the A/V network interface 650. Host processor 310 may be comprised of a single microprocessor such as a Pentium processor, but is not limited to this configuration as it may be embodied as a single integrated circuit (IC), a plurality of integrated circuits or other components connected or grouped together, such as microprocessors, digital signal processors, ASICs, associated memory (such as RAM and ROM), and other ICs and components.

Referring to FIG. 5, DVAD 600 is configured to provide both telephony (POTS) and videophone messaging services, utilizing host processor 310 for all command and control functions, SDRAM 315 and HDD 320 for storage requirements, decoder 350 for conversion to suitable audio and visual signals for display, and display devices 370 for video output. Additionally, DVAD 600 utilizes video camera 631 for video input of the outgoing videophone message (such as a video camcorder) to the host processor 310. When providing POTS service, a TAD portion (to be discussed below) of DVAD 600 interfaces with typical, existing twisted-pair cabling in the user premises, so that any telephone in the user premises may be used in conjunction with DVAD 600 and STB 300.

The radio frequency input video signal representing the incoming videophone message may be displayed on any of the display devices 370 connected to the STB 300 within the user premises, using a vacant channel within a CATV downstream frequency band (for example, channel 3 or 4). The RF input video signal is originally received from a network via communication channel 665 (not shown) in preferably a modulated digital form, such as digital data modulated and encoded utilizing a protocol such as CACS.

The A/V signal originating at the user's location, to be transmitted as the OGM via host processor 310, and the A/V network interface 650 to an external network or another videophone caller, originates from video camera (or camcorder) 631. Video camera 631 may preferably produce an outgoing video signal, such as an NTSC/PAL composite video signal 636, which may preferably be modulated on channel 3 or 4 (61.25 or 67.25 MHz). This RF analog video signal 636 from the video camera 631 is sent to camera interface 637, which converts the signal to digital, and is then compressed in compressor 638, prior to sending it to host processor 310. Alternatively, camera interface 637 is unnecessary if camera 631 is a digital camera. The OGM is preferably stored in storage (SDRAM 315 or HDD 320), to be accessed by host processor 310 when an incoming videophone call is detected and the user does not initiate communication. The OGM is then retrieved and sent, via a directional coupler 666 (at 1.2 GHz or 900 MHz) from host processor 310 to A/V network interface 650 for transmission as a compressed, digitized A/V signal to a network or the caller over channel 665.

Referring again to FIG. 5, DVAD 600 also includes circuitry for handling conventional voice messages. The voice message (telephone) answering device portion of DVAD 600 is described in detail in co-pending U.S. patent application Ser. No. 09/826,504 to Adrian Yap et al., entitled “DVR TELEPHONE ANSWERING DEVICE”, filed on Apr. 5, 2001, incorporated by reference in its entirety.

The voice message (telephone) answering device portion includes a high impedance telephone line interface 605 that receives analog voice signals along with the Caller ID signals that are generated by a telephone network or service provider. Additionally, interface 605 is configured to receive DTMF signals in addition to analog voice signals. The Caller ID and analog voice signals are sent from telephone line interface 605 to be received by a TELCO modem 610. TELCO modem 610 includes an FSK/receiver demodulator 616 and a Voice Digitizer 615. FSK/receiver demodulator 616 demodulates the Caller ID signals to provide a digital representation of the received telephone number, and Voice Digitizer 615 converts the received analog voice to a digital voice signal.

The digital voice signal output from Voice Digitizer 615 is then encoded in an audio encoder 617 before being routed to STB 300. Audio encoder 617 may be an MPEG encoder for example, but is not limited to MPEG encoding, as other techniques or encoders known in the art like a WINDOWS media encoder may be used. Alternatively, instead of providing a hard-wired audio encoder 617 in DVAD 600, host processor 310 may effect encoding of the input digital voice signal using embedded encoding algorithms or software.

Although the device between the phone line and STB 300 is described as a TELCO modem 610, the present invention is not limited to such. Alternatively, the device between STB 300 and an external device (such as a caller, PC, etc.) could be any of DSL, Home LAN, cable modem, satellite or optical interface, and any other known communication interface which would enable communication between STB 300 and an external device. Such an interface could enable the communication of text or sound files to be passed digitally, under control of host processor 310 from HDD 320 through the suitable interface (via a serial port in STB 300 for example) to an external device such as a PC.

The TELCO modem 610 then outputs the collective digital representation of voice and phone number via PCI bus 305 to be processed by host processor 310, then temporarily stored in buffer 315 for ultimate storage in HDD 320. Within host processor 310 is a voice recognition engine 625 that converts, under the control of the host processor 310, the digital voice received (and stored in HDD 320) to a text representation that may be displayed after decoding and encoding on a suitable display device 370.

There is also a DAC 620 operatively connected between data bus 305 and telephone line interface 605. DAC 620 is a digital to analog converter, and outputs an analog signal to be transmitted to the telephone network or service provider. This signal may be an out going voice-only message (OGM) sent to a caller by the DVAD 600.

Additionally, there is a signal line 630 between telephone line interface 605, A/V network interface 650 and host processor 310 that represents a communication path for detection of OFF-hook and ON-hook signals. These OFF-hook and ON-hook signals are sent to host processor 310 to determine whether or not DVAD 600 will be placed in some active state (answering or recording a message) or an idle state.

While a primary function of DVAD 600 and STB 300 is to provide full-duplex video communications, other functions are also available in the preferred embodiment.

For example, one such function is a “spy camera” function which allows the user to view the video from the video camera 631 on the screen of a display device 370, such that the RF input video signal is demodulated (from 1.2 GHz or 900 MHz), remodulated onto a video RF carrier, and utilized as an RF output video signal to be decompressed and converted into a suitable NTSC/PAL TV signal for display on display device 370. Such a feature is especially valuable for local surveillance, such as for home security or for baby monitoring.

Also, a picture-in-picture (or multiple window) function may be provided, in which a user may view a small window of the video from video camera 631 along with the received video from another location on display device 370, for example, to provide baby monitoring within the small window while simultaneously watching a movie or video content received by the STB 300.

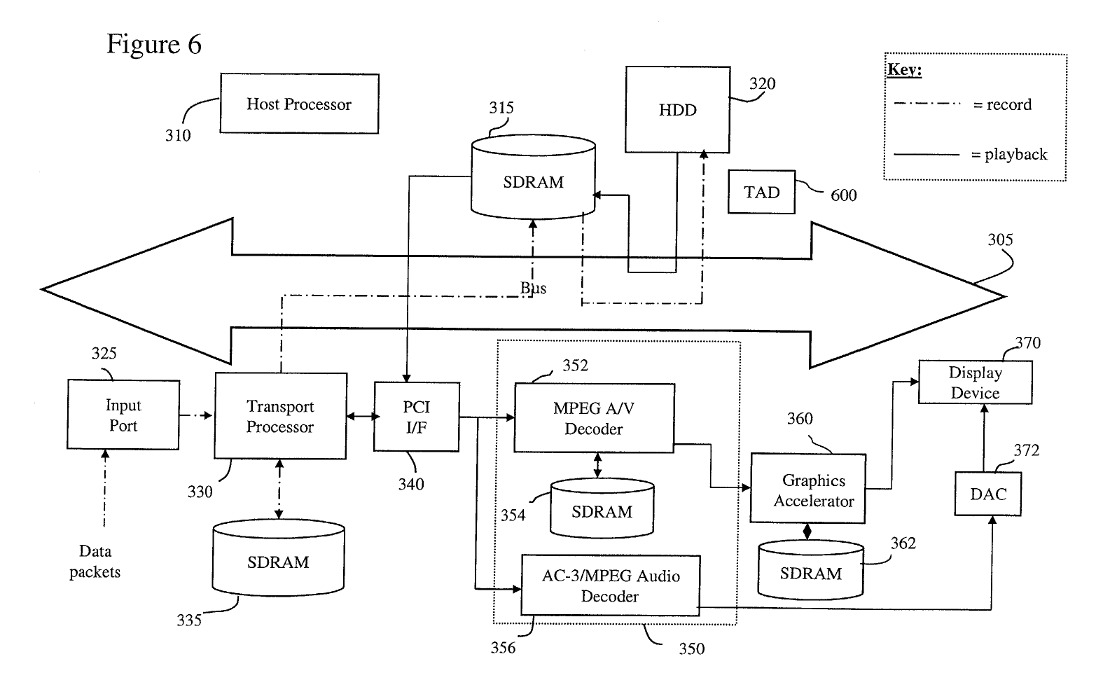

General recording and playback paths of the STB 300 are described in accordance with FIG. 6. FIG. 6 shows the recording and playback data flows among the various components of the STB 300, and is background for the recording and playback paths for DVAD 600 operations that are discussed later below. Some of the connections between components, and associated reference numerals from FIG. 3 may have been eliminated in FIG. 6 in order to highlight the data flow that is shown using dashed lines (see Key).

As shown in FIG. 6, A/V data of a selected or desired event, program and/or broadcast is received by input port 325 (typically the data is received in packetized and encrypted form) and fed to the transport processor 330. The transport processor 330 then transfers the received A/V data to SDRAM 315. Digital recording is accomplished by the host processor 310, which transfers the A/V data buffered by SDRAM 315 to the HDD 320. In other words, the SDRAM 315 serves as a buffer that buffers data sent by transport processor 330. This allows the host processor 310 to control the recording onto the HDD 320 when host processor 310 time is available. When a sufficient amount of programming data has been accumulated in the SDRAM 315, the host processor 310 transfers the data from the SDRAM 315 to the HDD 320 for recording therein.

In an alternative record path, A/V data is fed from the input port 325 to the transport processor 330. The transport processor 330 then transfers the received audiovisual data to the PCI I/F 340. The PCI I/F 340 receives audiovisual data from the transport processor 330 via bus 305, and sends this data to host processor 310, more particularly to SDRAM 315.

Digital recording is accomplished similarly, with SDRAM 315 serving as a buffer that temporarily stores data sent by the PCI I/F 340. This allows the host processor 310 to control the recording onto the HDD 320 when processor time is available. When a sufficient amount of A/V data has been accumulated in the SDRAM 315, the host processor 310 transfers the data from the SDRAM 315 to the HDD 320 for recording therein. To record data, the host processor 310 may also inform the PCI I/F 340 of available start addresses in the SDRAM buffer space 315 to which data may be buffered for eventual recording in HDD 320.

The operation of playing back the recorded A/V data that represents a stored event, program, broadcast, videophone message etc. in STB 300 is now described. Referring again to FIG. 6, when the viewer turns the STB 300 on, the viewer is given the option to playback any of the previously recorded programs, events, broadcast, phone messages, etc. This may be done, for example, by using a remote control or other suitable user command interface (not shown) to access a menu on display device 370. If the viewer selects a desired event, the corresponding A/V data (which typically may also include system time and conditional access packets) are retrieved from HDD 320.

In particular, when the user selects the playback option, the selected A/V data recorded on HDD 320 is sent via bus 305 to a queue in SDRAM 315. Next, the buffered data is sent from SDRAM 315 via bus 305 PCI I/F 340, which in turn sends the selected A/V data to decoder 350. More specifically, the video portion of the bitstream is sent to MPEG A/V decoder 352, with the audio portion being sent to AC-3/MPEG audio decoder 356.

Within decoder 350, MPEG A/V decoder 352 may be provided with an SDRAM 354 in order to more efficiently decode the MPEG bitstream received from PCI I/F 340. SDRAM 354 is similar to SDRAM 315 discussed above in its construction. SDRAM 354 temporarily holds the encoded video bitstream data, and also provides the three frame buffers required for MPEG decoding, as is known in the art. Thereafter, the decoded A/V data is output to GA 360 for conversion to an analog format, so that it may be displayed on display device 370. From this point on, the playback data looks, for all intents and purposes, identical to the originally recorded event, program, broadcast, etc.

Similar to the various trick mode operations available to the user when playing back recorded programs with STB 300, DVAD 600 also included several trick modes. These include variable speed playback, where the user, via a suitable user interface such as remote control 400, can quickly scan through videophone messages at fast, slow and super-slow speeds. These features are particularly useful to understand information that was left abruptly or is unintelligible at normal speeds. Preferably, these trick mode features are controlled by host processor 310, to be initiated by a user when desired as he/she views recorded messages on display device 370.

Additionally, while viewing videophone messages on display device 370, the STB 300 with DVAD 600 is configured so as to temporarily suspend playback (i.e., freeze-frame playback) to record an inbound message. This is based on the principle of bandwidth restriction. Host processor 310 can still process an inbound call since the freezing of playback data provides enough bandwidth to process the incoming message. Once the incoming message has been processed and stored, playback can re-commence.

Moreover, STB 300 with DVAD 600 may be configured so as to simultaneously play the OGM to a caller for recording an incoming videophone signal while currently playing back a recorded program, videophone message, etc. Specifically, host processor 310 accesses the OGM from storage and sends it out through interface 650, and receives the incoming message which is temporarily cached in SDRAM 315, while the recorded data is accessed from HDD 320 for playback on display device 370. Once HDD 320 is ready (i.e., the playback function has been completed), host processor 310 directs to SDRAM 315 to send the cached message to HDD 320 for permanent recording. This feature is also limited to the storage capacity and compression efficiency of the SDRAM 315 and HDD 320; thus the incoming signal may alternatvelyalternatively be recorded directly on HDD 320.

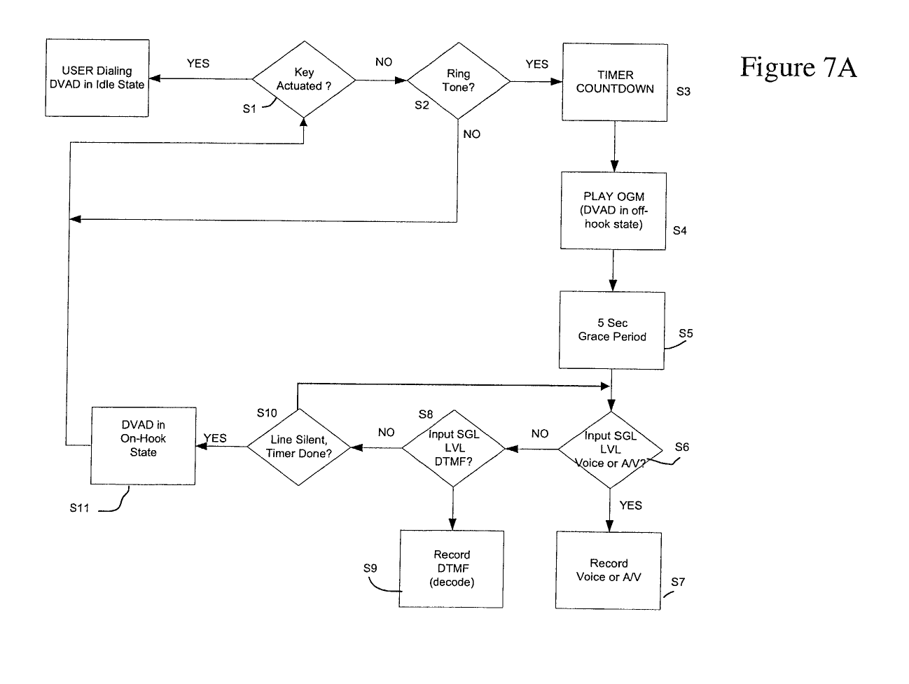

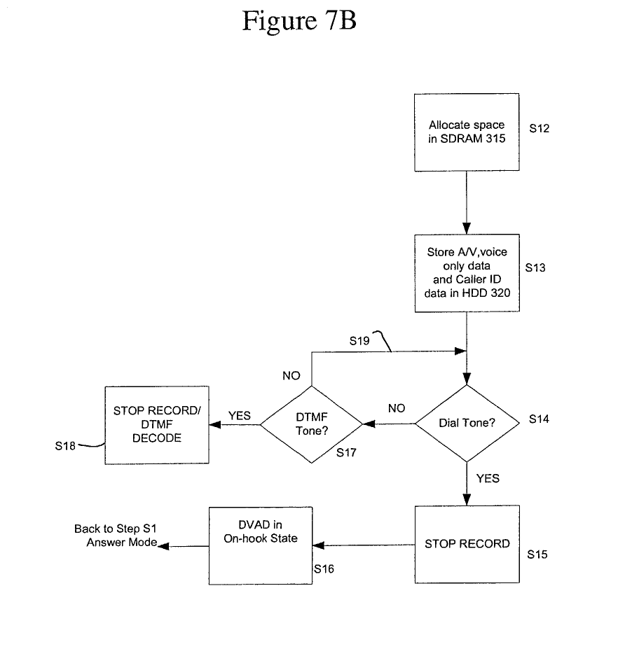

The architecture of the STB 300 and the operations of general recording and playback having been described, exemplary answer and record modes of the DVAD 600 are now briefly explained in reference to FIGS. 7A and 7B.

Referring to FIG. 7A, the DVAD 600 first determines (Step S1) if the user has pressed a number key on the DVAD keyboard (not shown). This is done under the control of the host processor 310 so as to read data at telephone line interface 605 or A/V network interface 650. If the user has pressed a number key, this is an indication that a user is calling out and DVAD 600 will remain in an idle state.

If no key has been pressed, DVAD 600 detects if a ring signal is present (Step S2). This ring signal may indicate that a caller is calling to initiate either a videophone conversation or conventional voice conversation over the phone, thus the detect step is applicable to either. Since any ring detection is immediately transmitted to host processor 310 via line 630, host processor 310 will initiate a timed countdown (Step S3), in which it reads a predetermined variable out of SDRAM 315 indicating the number of rings to wait before answering. For example, this could be set to answer immediately, at two, four, eight rings, etc. The finite time duration corresponds to the number of rings, after which host processor 310 accesses an outgoing message (OGM) pre-stored in SDRAM 315 or HDD 320, to be sent out to the caller (Step S4) via either DAC 620 and interface 605 (if it is a conventional voice OGM), or via coupler 666, RF modulator/demodulator 670 and A/V network interface 650, if the desired outgoing message is set to be a videophone outgoing message). DVAD 600 is thus placed in an off-hook state while the desired OGM is played back to the caller, either orally via telephone line, or via channel 665 to be displayed as a videophone OGM on a display of the caller

When the playing of the OGM is completed (voice or videophone), host processor 310 preferably waits 5 seconds (Step S5). This 5-second grace period prevents malfunction of the DVAD 600 due to silence by the natural pause or hesitation of a caller before or during enunciation of a message. The host processor 310 then determines if voice signals, A/V signals, or DTMF signals are being transmitted. The host processor 310 can distinguish four states during a call—voice signals, DTMF signals, A/V signals or dial tone/silence—by reading the level and modulation of the signals on the telephone line. The host processor 310 distinguishes between the tones of DTMF signals and the signal level ranges associated with human speech detected on the telephone line. If only voice signals are detected (Step S6), the host processor 310 immediately executes a voice record routine (Step S7) already outlined with reference to FIG. 6. If no voice or video is present on either the telephone line or communications channel, but DTMF signals are being transmitted (Step S8) over the telephone line, the host processor 310 executes a DTMF decode routine (Step S9) that is well known in the art and therefore only generally explained herebelow. If both audio and visual signals are present, then host processor initiates a record routine to record the videophone message.

If, however, there is determined a dial tone or silence (Step S10) lasting for 5 seconds, the host processor 310 causes the DVAD 600 to go into an on-hook mode (Step S11 ) which hangs up the phone and terminates the call, otherwise returns to Step S6 again. The DVAD 600 now returns to its initial state in the answer mode routine of looping and checking for a user key touch and waiting for a ring signal.

A DTMF routine preferably would be initiated by host processor 310 and decodes the DTMF signals keyed into the telephone by the caller and stores the code in SDRAM 315 and links it to the HDD 320 if only a voice message is recorded. This process sets up data memory areas in SDRAM 315 for receiving the DTMF signaling and links the data memory to voice message memory areas in HDD 320 if only a voice message has already been recorded. If a voice message has not yet been recorded it allocates an available message number in case a voice message is left later. This allows the system to be flexible and will allow the caller to key in a DTMF I.D. code anytime during the message sequence.

FIG. 7B illustrates an exemplary record mode for DVAD 600 in accordance with the invention. Initially, temporary space in SDRAM 315 is allocated (Step S12) for storing the received digitized A/V signals, in order to allow time for the host processor 310 to prepare HDD 320 for storage. This step points to a data memory position for the caller ID signal, and a voice and video memory position for the A/V message in SDRAM 315. When HDD 320 is ready, it is accessed by host processor 310 in order to store the caller ID and A/V data together (Step S13) (i.e., they are linked and associated within HDD 320).

These digital signals are being stored in parallel with a task of determining the line status. This is where host processor 310 first checks for a dial tone via line 630. If it is found (Step S14), recording is stopped (Step S15) and the DVAD 600 is placed in an ON-Hook state and returns to the answer mode (Step S16). If no dial tone is found, the line is checked for a DTMF tone and if that is found (Step S17), the aforementioned DTMF routine is performed (Step S18). On the other hand, when a DTMF tone is not detected, a dial tone is re-checked (Step S19), and once the dial tone is present, DVAD 600 is placed in an ON-Hook state and returns to the answer mode.

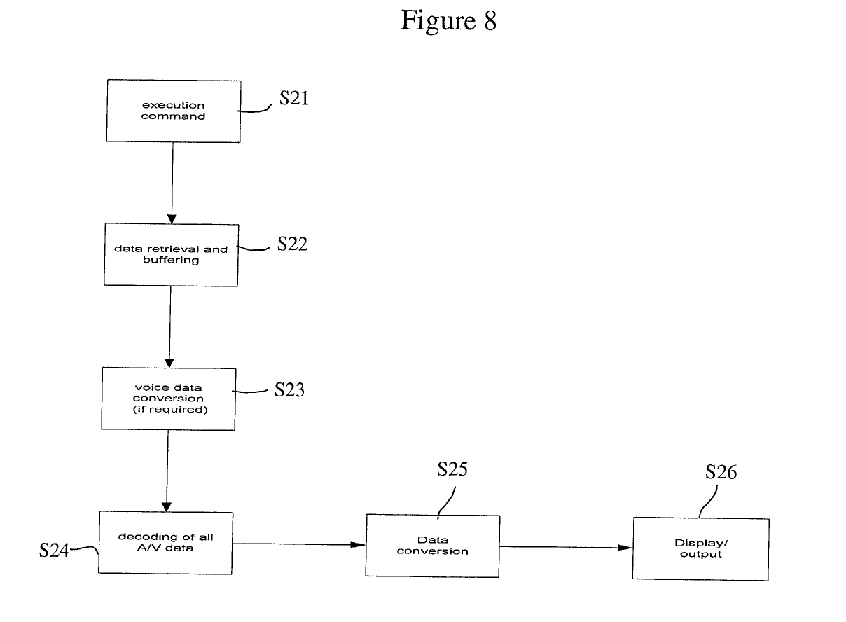

FIG. 8 illustrates a general playback flow diagram for a stored videophone message in accordance with an exemplary embodiment of the invention. As the playback of telephone messages is the subject matter of co-pending U.S. patent application Ser. No. 09/826,504, it is not discussed herein.

By utilizing a suitable interface, a user or viewer may elect the option to playback any of the previously recorded videophone messages on a display device 370 operatively attached to STB 300. This may be done, for example, by using a remote control or other suitable user command interface (not shown) to send commands to a user interface in host processor 310 to access a menu on a screen of the display device 370. If the viewer selects a desired message for playback on the screen, the corresponding A/V data (hereinafter “DVAD data” for clarity, is retrieved fro data, but could also be text and/or Caller ID data.

In particular, when the user desires to playback a recorded videophone message, he/she sends a command (Step S21) to user interface 311 of host processor 310 directing that the corresponding DVAD data recorded on HDD 320 be retrieved from HDD 320, via bus 305 to a queue in SDRAM 315 (Step S22). In the event the user desires to read a text representation of the voice message, the digital voice data portion of the DVAD data is subject to processing by voice recognition engine 625, which converts the digital audio voice data (Step S23, if necessary) to text.

Otherwise, the buffered digital A/V data is sent directly as a DVAD data stream from SDRAM 315 via bus 305 to PCI I/F 340, which in turn sends the selected DVAD data to decoder 350 (Step S24). More specifically, digital video data is sent to GA 360 through MPEG A/V decoder 352, with the audio portion (digital voice) being sent to AC-3/MPEG audio decoder 356. Alternatively, the DVAD data can be conveyed directly to MPEG A/V decoder 352 since decoder 352 is capable of decoding audiovisual data. Thereafter, the DVAD data stream, and hence the videophone message, is displayed on display device 370, with the digital audio data portion of the DVAD stream being fed to DAC 372 to convert it to analog sound, for emission from a speaker of display device 370..

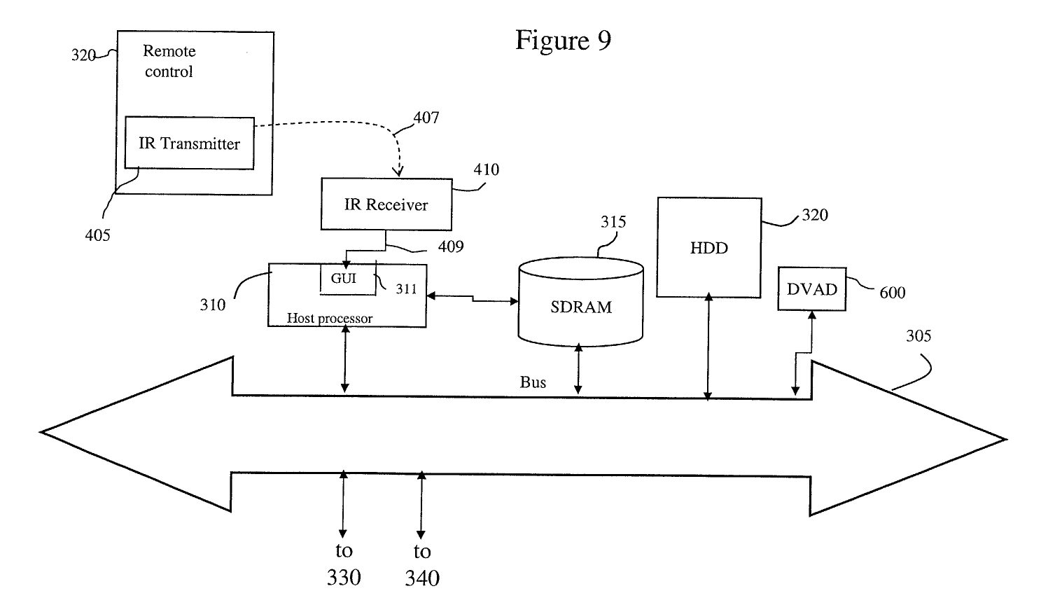

FIG. 9 illustrates a partial block diagram of FIG. 3, so as to show an exemplary communication path between a remote control device 400 (not shown in FIG. 8) and the host processor 310 of STB 300. In FIG. 9, there is illustrated a remote control device 400 which is in communication with the host processor 310 via GUI 311 in order to send commands for operating features or functions of the DVAD 600 and/or to display menus associated with DVAD 600 operation and functionality on display device 370 for example. The remote control device may be a device that is specific to the STB 300 or DVAD 600, and/or may be a universal remote control device which controls various individual components connected within a home entertainment system (TV, stereo, tape deck, DVD player, CD player, STB, DVAD, etc.)

As is well known in the art, the remote control device 400 may include a remote control transmitter 405 therein for transmitting various key or pushbutton-associated signals (commands) selected by the viewer or user to perform certain DVAD functions, to display certain parameters or data associated with the STB 300 and/or DVAD 600. These are sent in the form of an infrared (IR) ray signal 407 for example, to the STB 300, and in particular to an IR receiver 410 that may be operatively connected to host processor 310. IR receiver 410 decodes the received infrared ray signal 407, such as by photoelectric conversion for example, and sends a system drive signal 409 (which is preferably a digital signal) to user interface 311 inside host processor 310. The host processor 310 thus analyzes the composed code information (i.e., the command data generated by the user) corresponding to the received system drive signal 409. This may be a command to display a desired parameter, menu or user-interface feature of the DVAD 600, for example.

Although the above communication path and interface to the STB 300 and DVAD 600 are explained with regard to using a remote control device, commands and/or processing necessary to display DVAD 600 parameters may also be initiated by a user actuating buttons, switches and/or keys that may be provided on, or integral with STB 300 and/or DVAD 600. Moreover, these buttons, switches and/or keys may interact with software or package programs within STB 300 (i.e., provided within SDRAM 315, HDD 320 or as part of host processor 310) in order to effect display of a status parameter on a screen of a device. These alternative interfaces provide redundancy for the viewer, as well as alternative means to display parameters, menus or functions of STB 300 and/or DVAD 600 on a display device 370.

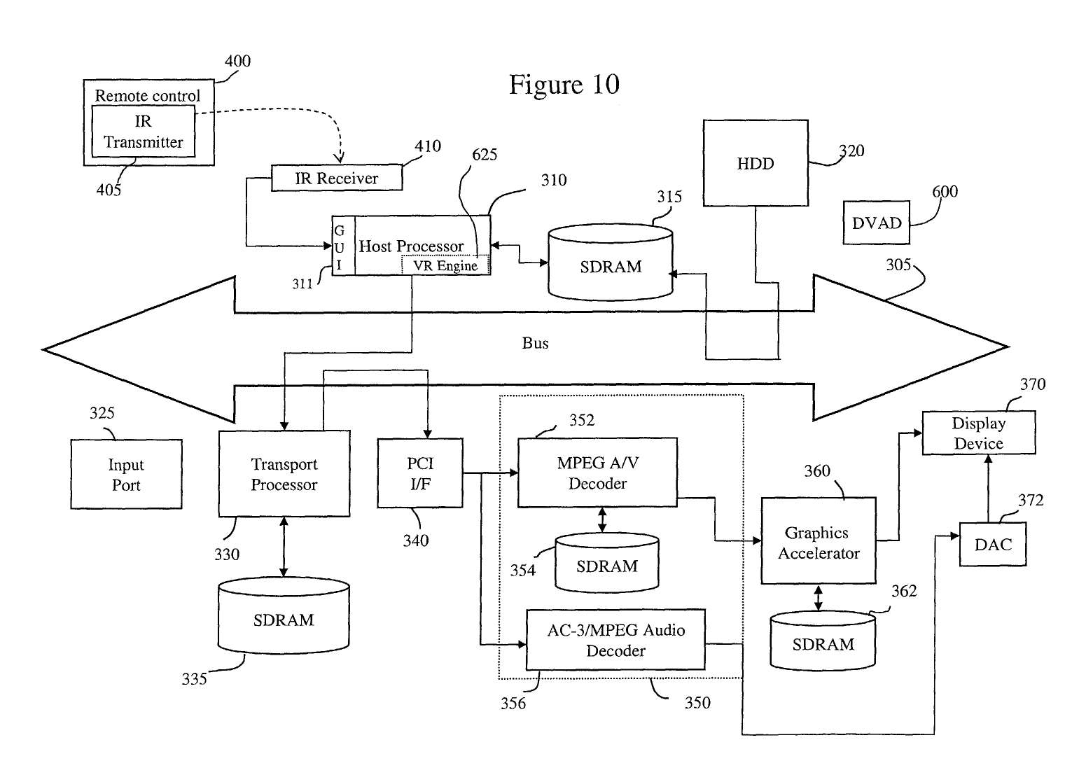

FIG. 10 illustrates the data flow from command signal to display, for a parameter, data or menu associated with DVAD 600 in accordance with the present invention. A plurality of parameters or data, such as recently received videophone messages, data for specific DVAD-related menus, etc., are stored in HDD 320. Additionally, certain ones of these stored parameters may be updated to reflect current status of the DVAD 600; for example, DVAD off-line, number of messages received today, etc. This may be done, for example, by using designated software programs or predetermined algorithms within host processor 310.

The host processor 310, via GUI 311, receives an IR ray signal (i.e., a command) from remote control device 400 that is converted into a digital signal. This signal may be a command directing that a certain parameter, menu or data associated with the DVAD 600 be displayed. Thus, host processor 310 retrieves the ordered DVAD data (this may be any or all of the digital A/V, audio, text or caller ID data, depending on the selected parameter and/or feature) from HDD 320 via SDRAM 315, where it is buffered temporarily after being sent from HDD 320, so that the A/V data may be processed by voice recognition engine 625. Host processor 310 sends the selected data (i.e., digitized voice, digitized A/V, digital text and caller ID signals) corresponding to the desired parameter, menu or function via bus 305 as a DVAD stream to PCI I/F 340, which in turn sends the selected data to decoder 350. From this point, the flow path is identical to that for playback described initially in FIG. 6. The decoded DVAD data is output to GA 360/AC-3/MPEG audio decoder 356; or directly to MPEG A/V decoder 352 for conversion to an analog format as required, so that the desired parameter may be displayed on display device 370.

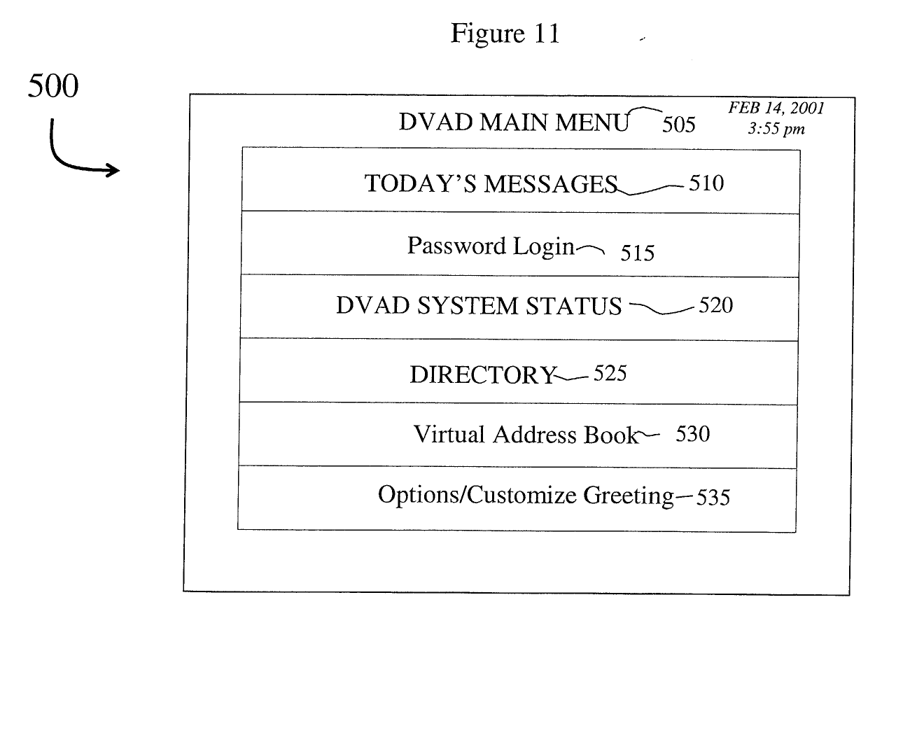

FIG. 11 illustrates an exemplary DVAD main menu screen 500 according to the invention. When a user or viewer sends a command to display a DVAD main menu, an exemplary menu 500 or status guide such as is depicted in FIG. 11 may be displayed on the screen of a display device 370. In an exemplary embodiment, various status parameters or features may be displayed in stacked cells or rows of the menu 500, each cell being assigned to a particular status parameter.

As shown in FIG. 11, a title line 505 such as “DVAD Main Menu” may be provided, along with various DVAD parameters or functions such as a “Today's Messages” cell 510, “Password Login” cell 515, “DVAD System Status” cell 520, “Directory” cell 525, “Virtual Address Book cell, 530, and an Options/Customized Greeting cell 535, which brings up a submenu to customize outgoing videophone greetings to callers, encrypt certain messages, and enable/disable DVAD features such as call blocking and call notification routing, for example. These features are only exemplary of the many other possible features or parameters of the DVAD 600 that a user may display in order to review.

To view the desired parameter, and/or to manipulate or display additional information such as sub menus, specified callers, etc., the viewer simply presses a designated key either on remote control 400, or locally at STB 300 or DVAD 600. In the exemplary embodiment this may be a scroll down key, left/right or up/down arrow button, for example, in order to highlight a specific cell. The parameter of the highlighted cell may then be actuated or implemented on the display by pressing an execution key, button, etc. on the remote control 400 or STB 300/DVAD 600, such as an “action”, “enter” or “execution” key as is known in the art. The present invention is not limited to these user command interfaces, of course, as any of the other exemplary user command interfaces may be implemented as well (i.e., in the event a PC is connected to STB 300, an input device such as a mouse may serve as the command interface).

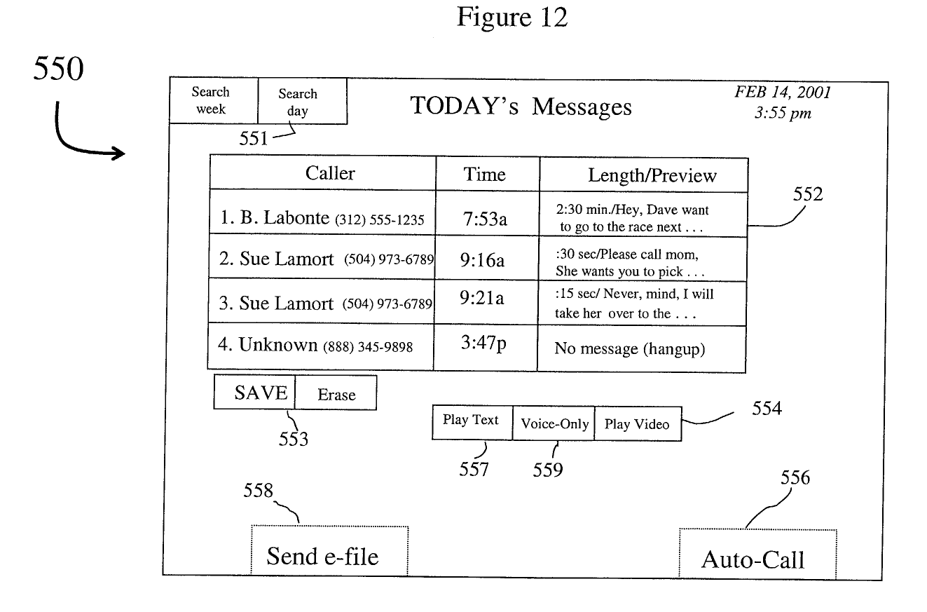

FIG. 12 illustrates a submenu associated with message management, including auto callback and external transmission of messages in accordance with the invention. Should the user select the “Today's Messages” cell 510, a submenu entitled “Today's Messages” (default) may be displayed on the display device 370. Submenu 550 includes a cell or window 552 listing the messages received that day. Each message includes at least the caller name and videophone or telephone number, and may be identified by the caller ID information received from the telephone network provider. Alternatively, in the case that the user does not subscribe to a Caller ID service, the caller may be identified from the recorded dial or DTMF tones that are identified by host processor 310 as matching a DTMF tone signature that corresponds to a name stored in a stored caller database in HDD 320.

Additionally, a short “text header”, i.e., starting portion or snippet of the complete text representation is displayed. This just alerts the user as to whether or not he/she wishes to view the entire message. The header display is set as a default, and is displayed regardless if the user elects to read or view the entire A/V or text message, or simply elects to hear the recorded voice message at a speaker of display device 370.

As shown in FIG. 12, the user may simply highlight a particular caller using remote control 400. Then the user has a variety of options. If the user wishes to save or erase the message, he/she simply selects the appropriate cell in the save/erase icon 551. If the user wishes to search for messages in another week or another day, the user selects search icon 553. Selection of search cell 553 brings up a submenu which may be entitled “Archived Messages” (not shown). This menu is essentially identical to that illustrated in FIG. 12, with the exception that the user may set a specified archived period by selecting one of several stored defaults (i.e., 1 week, 1 month, 3 months up to 1 year), or by entering a specified time period (i.e. a date) using remote control 400, for example.

If the user simply double-clicks on the selected caller, or selects the “Play Video” icon 554, the incoming videophone message (if recognized as such by host processor 310) will be retrieved from HDD 320 and displayed on display device 370. Alternatively, the user may select the “Play Text” icon 557 or “Voice-Only” icon 559 to initiate the corresponding playback of a telephone message and/or audio portion from a stored A/V videophone message. Further, the user may simply highlight the header text in the preview area of cell 552 in order to read the full text message. In an exemplary case, this may be embodied as a pull down window that displays the entire message, or a completely separate display containing only the text of the message. However, the display format is not limited to the above, as any suitable and known display implementation in the art is applicable.

Additionally in FIG. 12, a user may desire to automatically call back the caller selected or highlighted on submenu 550. To do so, a user would highlight the desired caller in cell 552 and then initiate the auto-call cell 556. For example, if B. Labonte was highlighted and the auto-call feature was enabled, host processor 310 would access B. Labonte's phone number stored in HDD 320, so as to produce the DTMF tones that are then sent to DVAD 600 (via line 630 through interface 605) for dialing out on the telephone line. Optionally, a confirmation block may be displayed upon selecting a desired caller for auto call back. This may be embodied as pop-up window or sub-screen, or any other display implementation known in the art.

Further in FIG. 12, a caller name may be highlighted and added to a virtual phone book by selecting the add to Virtual phone book cell 569. The virtual phone book is embodied as a pop-up menu of names and contacts that are frequently called by the user, for fast access.

Yet still further, a user may desire to send a text or sound file corresponding to the message of a selected caller to an external medium such as e-mail via the internet. To do so, a user would highlight the desired caller in cell 552 and then initiate the send e-file cell 558. As will be further explained below, this initiates a pop-up window or sub-screen interrogating the user to determine whether an A/V file of a videophone message, text file of a telephone message, sound (voice) file, or both are to be sent, and asking the user to input the address to send the file to. After selecting the desired parameters, the user simply actuates a send icon in order to direct the host processor 310 to send the specified file via an interface over a suitable telecommunications line to a plurality of alternate devices or receiving locations. This interface may be embodied as any of a dial-up modem, cable modem, ISDN, Home LAN, DSL, satellite, etc.

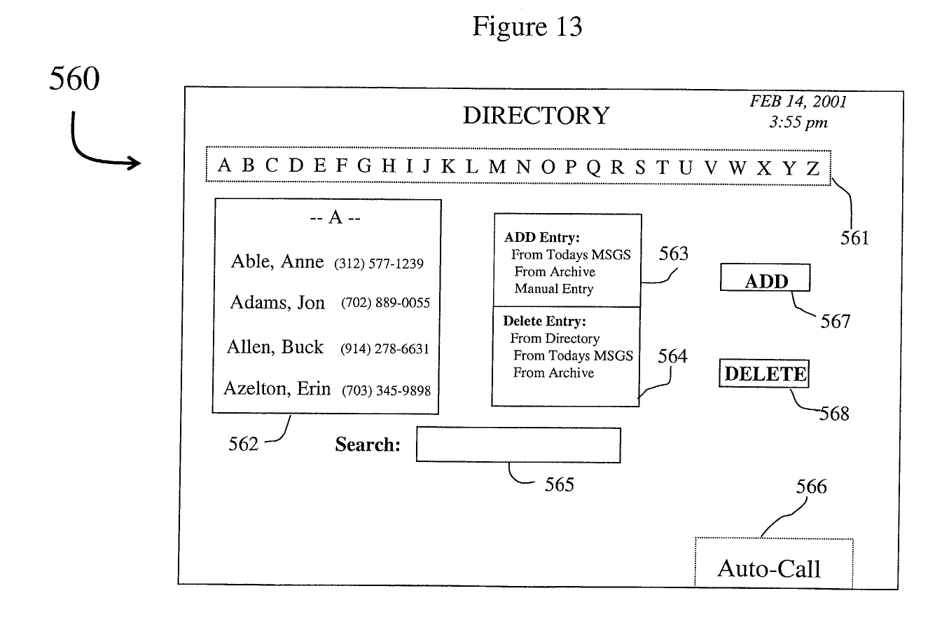

FIG. 13 illustrates a submenu associated with a displayed directory, including entering caller information and accessing stored caller data. Directory submenu 560 includes an alphabetical A-Z list cell 561, address list 562 cell that as a default lists the first few names of A, and can be scrolled down if desired, add entry cell 563, delete entry cell 564, search cell 565, an auto call back cell 566, add icon 567, and delete icon 568.

A user may access submenu 560 from DVAD Main menu 500 by actuating “Directory” cell 525. Alternatively, actuating Search Cell 535 from DVAD Main menu 500 will highlight the corresponding search cell 565 in submenu 560 to prompt the user the enter the first few letters of the last name of a desired caller. In doing so, address list 562 will simultaneously scroll down to the letters corresponding to the search, similar to what is available in e-mail contact search applications. This provides a quick and easy means of obtaining stored caller identification.

Over time, the user may build up the address list 562 by manually entering caller information. This can be done by actuating the manual option in the add entry cell 563. However, the system of the present invention automatically stores, temporarily in SDRAM 315, incoming caller information that is detected by DVAD 600. More preferably, the user will actuate the “From today's messages sub-line or “From Archive” sub-line in add entry cell 563 in order to display a listing of current or archived messages and caller information.

Then, the user can simply highlight those names that are desired to be permanently stored in the address list 562, which is embodied as a directory database that is stored on HDD 320, and then actuate an ADD icon 567 displayed on submenu 560, which could also be embodied as a pop-out or pull-down window (not shown) from add entry cell 563. Similarly, the user may periodically review address list cell 562 to delete names from the database, by highlighting the appropriate names using a suitable interface such as remote control 400, mouse, keyboard etc., and then by actuating a delete icon 568 displayed on submenu 560, which could also be embodied as a pop-out or pull-down window (not shown) from delete entry cell 564.

Still further, the present invention envisions the ability to set defaults as to when temporarily stored information residing in SDRAM 315 is to be erased, so as not to overly burden the processing capability of the system. For example, the system could be configured to permanently store (in HDD 320), or erase, caller information of the archived messages or most recent (Today's Messages) after a set period of time. Alternatively, and depending on the available storage capacity, caller identification information of all received messages could be permanently stored and organized in HDD 320 by setting a particular default. Such defaults could be set by the user actuating the DVAD System Status cell 520, which would display a corresponding sub cell (not shown) of specified system parameters and defaults to be reviewed, set and/or adjusted by the user regarding the management of received message traffic.

A user may also desire to automatically call back a caller selected or highlighted on submenu 560. To do so, a user would highlight the desired caller in address list cell 562 and then initiate the auto-call cell 566. As explained in FIG. 12 host processor 310 would access the phone number of the selected name from HDD 320, so as to produce the DTMF tones that are then sent to the DVAD 600 for dialing out on the telephone line. As noted also above, a confirmation block may be displayed upon selecting a desired caller for auto call back. This may be embodied as pop-up window or sub-screen, or any other display implementation known in the art.

As a further variation of this feature, DVAD 600 can be programmed to send specific or customized OGMs to specific callers. Based on a detected caller-ID signal or digital A/V footprint, host processor 310 may access a specified OGM from storage to broadcast via interface 650 and channel 665 to a particularly-identified incoming caller. Moreover, the user can modify a previously edited/recorded outbound greetings (OGM) using voice recognition and artificial intelligence algorithms available in a edit greeting option to simulate actual user presence for receiving an incoming call. Specifically, the user may simulate his presence at home using a virtual representation (e.g. “Max-Headroom” video image) and a prerecorded voice-snippet of his voice in creating or modifying the OGM. This can be set to play as the default OGM for example, or preferably as a precursor to playing the OGM when an incoming videophone call is received.

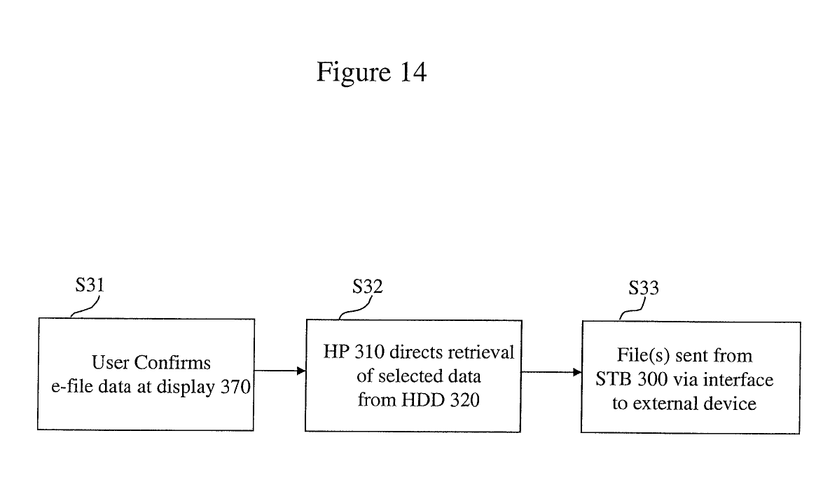

FIG. 14 illustrates how caller information in A/V file, text and/or sound file format is sent to a remote destination in accordance with the “send e-file” cell 558 of FIG. 12. As noted above, the interface between STB 300 and an external device (such as a caller, PC, etc.) could be any of a TELCO modem DSL, Home LAN, cable modem, satellite or optical interface, and any other known communication interface which would enable communication between STB 300 and an external device. Such interfaces enable the communication of text or sound files to be passed digitally, under control of host processor 310 from HDD 320 through the suitable interface (via a serial port in STB 300 for example) to an external device such as a PC.

For example in FIG. 14, once the user actuates the send e-file cell 558 of FIG. 12, the user may get a confirmation message in pop-up graphical form or on a separate screen of display device 370 to verify (Step S31) that the desired sound and/or text file to be sent to the external device (a PC of another user or the user's PC at work in this exemplary embodiment). Once confirmed, the host processor 310 directs the retrieval (Step S32) of the selected file(s) from HDD 320, for transmission (Step S33) from a serial port of the STB 300 via a suitable interface (such as interface 650 and channel 665) to the desired location. Preferably, the user could receive a visual prompt on the screen of display device 370 indicating that the file has been successfully sent, or noting errors in transmission.

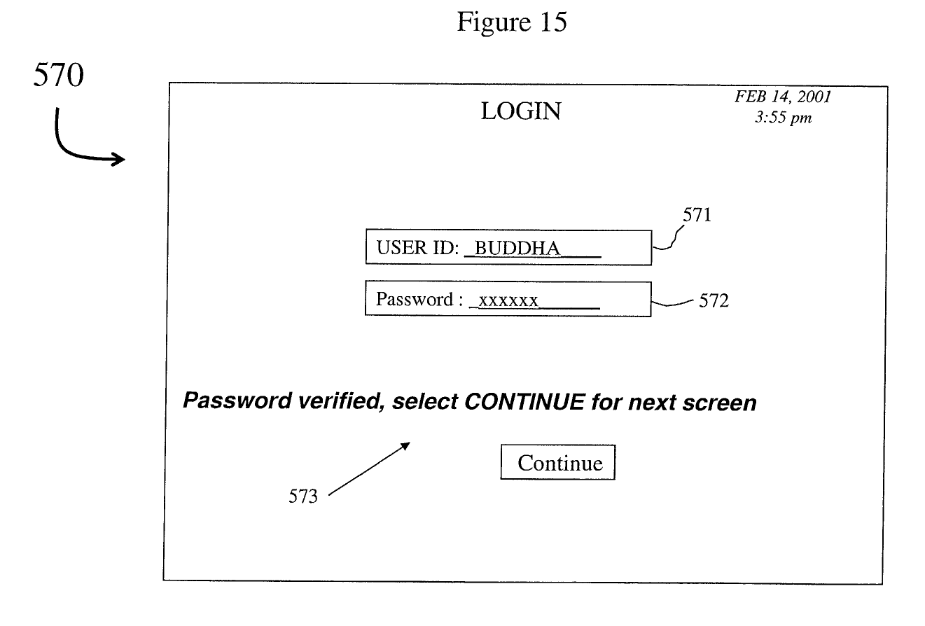

FIG. 15 illustrates a submenu of an exemplary private box arrangement requiring password entry. This feature envisions the case where the DVAD 600 has multiple users maintaining their own separate voice mails or private databases of caller information on HDD 320. Preferably, the “LOG-IN to access private voice mail” cell, 530 in DVAD Main Menu 500 of FIG. 11 may be optionally set to require a secret code or password to be entered by a user before he/she can access their messages and personal directory.

A user accesses a pass code or password verification screen 570, entitled “LOG IN” for example, from DVAD Main Menu 500 by actuating “Password-Login” cell, 515. As shown in FIG. 15, the user is prompted for their ID at cell 571 (a last name for example) and a password (cell 572). Once entered, a suitable confirmation or rejection message 573 may be displayed or scrolled beneath the (as shown in FIG. 15, “Password verified, select CONTINUE for next screen” is just one example, this could also be a separate screen display), with the display immediately thereafter shifting back to any of DVAD Main menu 500, Today's Messages submenu 560, or another submenu.

The system default could be set to display the DVAD Main menu 500 again after verification; or alternatively the user can select a desired menu or submenu for the default display after password verification by accessing submenus corresponding to the DVAD System Status cell 520 in order to set the desired configuration. Since methods of implementing password protection for voice mail databases and personal messaging are well known in the art, any suitable password protection algorithm or software configuration is acceptable and can be integrated within host processor 310 or accessed from SDRAM 315 by host processor 310.

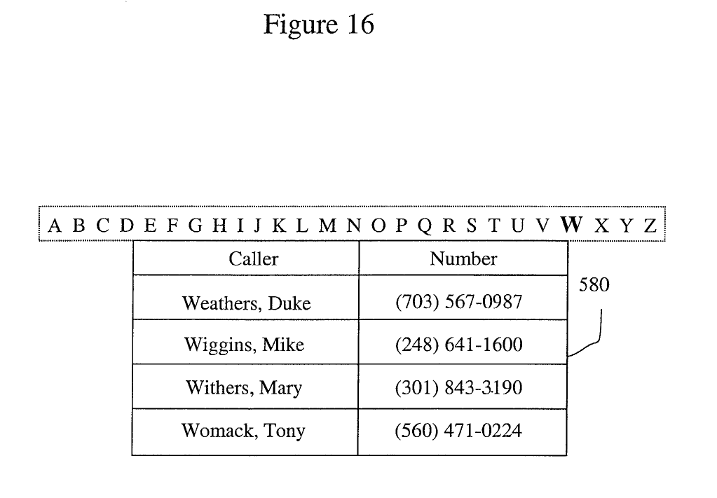

FIG. 16 illustrates an exemplary pop-up menu that is displayed when the virtual address book cell 530 of FIG. 11 is actuated. As shown in FIG. 16, a pop-up menu 580 listing frequently called contacts (here shown alphabetically) is displayed. Of course this list may be edited using the add to virtual phone book icon 569 of FIG. 12, or may be edited simply by re-clicking or right-clicking on the pop up menu, providing a further layer of edit options (not shown).

Moreover, pop-up menu 580 may also include URLs for streaming audio and/or video, so as to handle voice over IP messages or calls originating from a browser instead of a videophone. This feature envisions communications between browsers instead of videophones, wherein DVAD 600 can handle communications from other browsers, cell phones or any other communication devices which may be configured to stream audio and video.

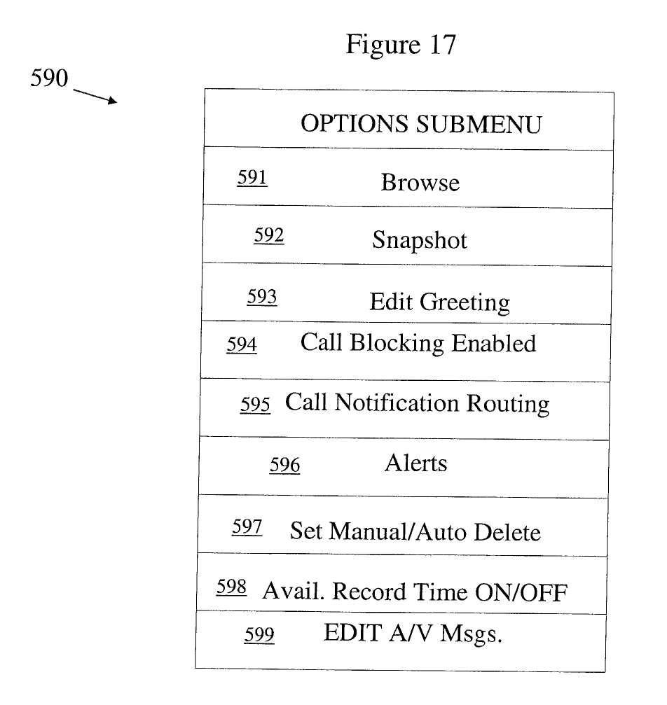

FIG. 17 illustrates a submenu that is displayed when a user selects the Options/Customized greeting cell 535 of FIG. 11. Submenu 590 includes options to customize the outgoing videophone greeting that is displayed to callers. For example, the browse icon 591 enables the user to browse a database on HDD 320 to search for selected A/V snippets. Additionally, the user may also access the active snapshot database via icon 592.

An active snapshot is another operational mode of the present invention which dumps the A/V stream from the GA 360 to another device such as a PC or other output device. In this way, the active snapshot can offload A/V segments (or entire programs or even the entire contents of the HDD 320) to another device or database. This active snapshot may be accomplished by feeding the decoded stream from the decoders 352, 356 (MPEG A/V decoder and/or AC-3/MPEG Audio decoder) to the display device 370 as shown in FIG. 6, for example. The output device 370 may be a PC, another HDD, CDR (recordable CD), or other digital device capable of storing the data.

Alternatively, the active snapshot may dump encoded or decoded data to an external device by having the host processor 310 route data from the HDD 320 to the PCI bus and eventually to the external drive, such as a storage device having a database (HDD 320).

As a further alternative, the active snapshot can dump analog data to the analog output device by feeding the decoded stream from the decoders 352, 356 (MPEG A/V decoder and/or AC-3/MPEG Audio decoder) to the DAC 372 and TV encoder 360 which converts the digital, decoded stream to an analog signal. The analog signal is then supplied to display device 370 as shown in FIG. 6. The display device 370 may also be a conventional VCR or other analog mass storage device.

Accordingly, by selecting the active snapshot database icon 592, the user can capture snippets of a digital A/V broadcast, (i.e. from an Arnold Schwarzenegger movie) so as to be played back as part of the outgoing videophone message (greeting) for incoming videophone callers. Additionally, an edit icon 593 provides a drop down menu of cut, copy, truncate and paste functions, enabling the user to cut-and-paste A/V data from storage in order to create a customized greeting for incoming videophone messages.

FIG. 17 also includes additional DVAD options. Two of these include a call blocking cell 594 and call notification routing cell 595. Selection of cell 594 allows the user to enable or disable call blocking, which only accepts an incoming call by recognition of originating number, voice recognition or picture recognition. Additionally, selection of call notification routing (CNR) cell 595 provides a drop down menu to notify selected callers or individual users of an incoming videophone call. Further in FIG. 17, a user can specify when “out-of-media” storage alerts are to be displayed on display 370. The user can simply set these graphic alerts by selecting alerts icon 596. Preferably, such alerts are embodied as blinking icons or “bugs on a screen”, to appear when HDD 320 capacity reaches a certain % of full (70, 80, 95%, etc.)

Further, the user may set whether deletion of messages is to be done automatically or manually by selecting cell 597, which preferably displays a pop-up menu to set automatic or manual delete of messages. Additionally in this pop-up menu, there may be an undelete option that allows a user to undelete messages designated for deletion, but not yet purged from HDD 320. This option is explained in detail in co-pending U.S. patent application (Ser. No. unknown) by Adrian YAP et al., entitled DIGITAL VIDEO RECORDER ENHANCED FEATURES (Atty. Docket No. PD-201168), the contents of which are incorporated in their entirety by reference herein. Additionally, the user has an option to display available record time on the screen of FIG. 11 by setting cell 598 to ON or OFF. The user may also edit A/V messages stored in HDD 320 by selecting EDIT cell 599, which enables cut, truncate and paste features to be applied to selected videophone messages.

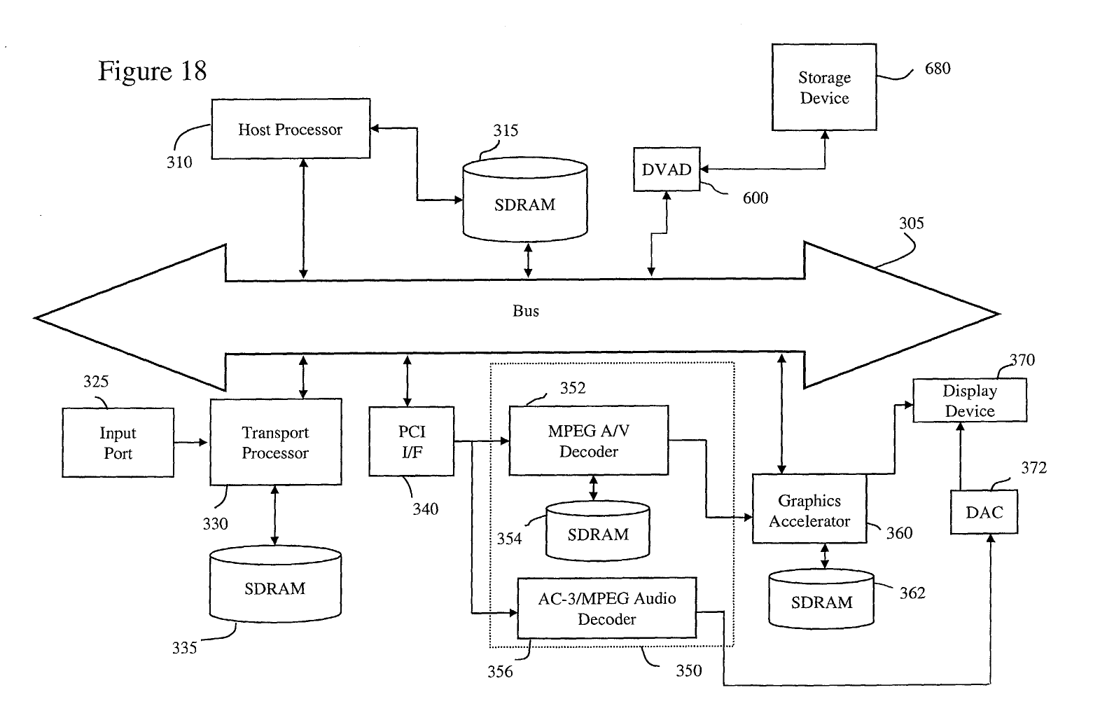

FIG. 18 illustrates an alternate embodiment of a DVAD connected to an external mass storage device and the host processor of the STB equipped with DVR in accordance with the invention. The structure and operation of this figure is substantially similar to that of FIG. 3 with the exception that the DVAD 600 has its own dedicated mass storage device 680 that is thus external to the STB 300. Similar to FIG. 3, host processor 310 remains the center of operations, but directs all telephone network or videophone related A/V data received by the DVAD 600 to the external storage device 680.

External storage device 680 may be any of known magnetic and/or optical storage devices, (i.e., embodied as RAM, a recordable CD, a flash card, memory stick, etc.). In an exemplary configuration, external storage device 680 may have a capacity of at least several Gbytes or more. Such a configuration may provide even more storage for the DVAD 600 while not burdening the processing capability of STB 300, so that the STB 300 may maximize is storage capacity for its primary purpose of recording and manipulating live programming.

Therefore, the present invention provides the ability to maintain a digital videophone answering device on a STB-equipped with DVR utilizing the audio and video features of the STB-equipped with DVR and associated display device(s) connected thereto. The DVAD 600 utilizes the same telephone and network/ethernet/T1-E1 lines as the STB-equipped with DVR, and may use memories that are integrated within the STB with DVR architecture, and/or utilize an external mass storage device or memory. Accordingly, the STB 300 is easily configurable as a DVAD 600, as it contains existing hardware and software necessary for most DVAD operations and functionality.

The DVAD 600 is capable of storing an enormous amount of both telephone and videophone messages as compared to conventional telephone answering devices. Further, various menu screens associated with DVAD 600 features, data or parameters may be displayed and manipulated by the user operating a simple graphical user interface such as a remote control, providing even greater flexibility.

The invention being thus described, it will be obvious that the same may be varied in many ways. For example, the functional blocks in FIGS. 1-6, 9, 10 and 18 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s).

Additionally, the inventive system may be embodied in a variety of ways; a STB 300 is just one example. Other examples include a personal computer (PC), TV or hardware card that is added to an existing apparatus such as a conventional STB, PC or TV. Still further, the inventive functionality may be downloaded or otherwise programmed into a STB, PC or TV. Moreover, the present invention is not limited to receiving only voice messages, as pager numbers and/or e-mail messages may be received by the DVAD 600 via suitable interfaces.

Alternatively in FIG. 5, and instead of encoding the digitized audio message via encoder 617 in the TAD portion 602 of DVAD 600, the analog incoming message may be digitized into Pulse Coded Modulation (PCM) data without further encoding in DVAD 600. In this scenario, digital voice data need not go through the AC-3/MPEG Audio decoder 356. Instead, the PCM data may be directly routed from DVAD 600 to DAC 372 for analog conversion prior to display at display device 370.

Further, although the DVAD 600 of invention has been described as processing digital A/V, analog voice and/or DTMF signals, it is easily recognized and within the purview of this invention that the system may process pulse signals or pulse tones as well. Such variations are not to be regarded as departure from the spirit and scope of the invention, and all such modifications as would be obvious to one skilled in the art are intended to be included within the scope of the following claims.

What is claimed is:

1. A digital videophone answering device operatively connected to a digital video recorder (DVR), comprising:
an interface for receiving audio and video (A/V) signals representing an incoming videophone message from a caller;
a processor for processing the received A/V signals representing an incoming videophone message; and
a display device for displaying the incoming videophone message,
wherein the processor directs storage of the received A/V signals to a mass storage device, controls decoding of the stored A/V signals representing the videophone message, and controls playback of the incoming videophone message on the display device.

2. The digital videophone answering device of claim 1, wherein the received videophone message is displayed on the display device, or, if the caller is not calling from a videophone, displayed as one of a stored personal identification picture of a known caller with either voice or text message, displayed only as a text message, or emitted as only a voice message of the caller.

3. The digital videophone answering device of claim 2, wherein a user sends a command via a user interface device selected from one of a remote control device, execution keys and buttons provided on the DVR, and execution keys and buttons provided on the digital videophone answering device in order to display the videophone message.

4. The digital videophone answering device of claim 1, wherein said mass storage device is contained within the DVR and is operatively connected to the digital videophone answering device via a bus, or is external to the DVR and directly connected to the digital videophone answering device.

5. The digital videophone answering device of claim 1, wherein said processor controls display of a videophone answering device main menu for selection of at least one of a plurality of parameters of the digital videophone answering device based on reception of a command to display the videophone answering device main menu by a user.

6. The digital videophone answering device of claim 5, wherein the user manipulates a user interface device to display said videophone answering device main menu on the display device, and further manipulates said user interface device to select desired parameters and/or submenus for display.

7. The digital videophone answering device of claim 6, wherein one of the parameters enables an A/V greeting of a caller to be shown on a display device, or, if the caller has no videophone, enables a pre-recorded video or still image of the caller to be displayed.

8. The digital videophone answering device of claim 1, wherein the mass storage device is a hard disk drive which stores a directory of caller data that may be accessed by a user, said directory embodied in a menu format on the display for adding, deleting or searching desired caller information.

9. The digital videophone answering device of claim 1, wherein the DVR is configured to freeze playback of received A/V messages to or from said mass storage device so as to free-up bandwidth for recording an inbound caller's A/V message on said mass storage device.

10. The digital videophone answering device of claim 1, wherein the DVR is configured to simultaneously record an incoming videophone message while a user is playing back recorded content on the display device.

11. The digital videophone answering device of claim 1, wherein the DVR is configured to display a picture-in-picture window of a recorded videophone message while the user is watching other content on the display device.

12. The digital videophone answering device of claim 5, wherein one of the parameters is a listing of all messages received with a given time frame, each listing including at least one of the name of the caller, videophone number, length of message including beginning header text of the message, and wherein the user has an option to automatically call back a caller by selecting the caller on the display with a specified key.

13. The digital videophone answering device of claim 12, wherein said given time frame is selected from one of a current day, a current week and a specified day.

14. The digital videophone answering device of claim 5, wherein one of the parameters accessible to the user is a virtual phone book listing all phone numbers of frequent callers and numbers that are frequently called by the user.

15. The digital videophone answering device of claim 14, wherein said virtual phone book includes URLs for streaming audio and/or video, so as to handle a voice over IP message or call originating from a browser, cell phone or other communication device having audio and/or video streaming capabilities, instead of a videophone.

16. The digital videophone answering device of claim 1, further comprising a video camera operatively connected to the processor for recoding an outgoing message to be displayed to callers.

17. The digital videophone answering device of claim 16, further comprising an input interface for inputting the outgoing message to the processor, the input interface enabling an A/V signal from the video camera which represents the outgoing message to be sent to the processor for eventual storage and display.

18. The digital videophone answering device of claim 17, wherein said input interface is embodied as at least one of an RF (channel 3/4) composite video channel, parallel port, USB, ethernet, 1394 port and satellite.

19. The digital videophone answering device of claim 16, wherein said video camera is configurable as a surveillance device that records the user's location to the mass storage device, and/or streams A/V data representing the user's location to both on-site and remote devices operatively connected to or in communication with the DVR.

20. The digital videophone answering device of claim 5, wherein one of the parameters is an active snapshot feature enabling the user to capture snippets of a digital A/V broadcast, so as to be played back as a greeting for incoming videophone messages.

21. The digital videophone answering device of claim 5, wherein one of the parameters is a cut-and-paste feature that enables the user to cut-and-paste A/V data from storage in order to create a customized greeting for incoming videophone messages.

22. The digital videophone answering device of claim 5, wherein one of the parameters is a call blocking feature which only accepts an incoming call by recognition of originating number, voice recognition or picture recognition.

23. The digital videophone answering device of claim 5, wherein one of the parameters enables the user to specify a fixed or variable record time and compression quality, wherein available recording time is based on capacity of the mass storage device.

24. The digital videophone answering device of claim 5, wherein one of the parameters enables user management of A/V message recordings via a plurality of selectable submenus.

25. The digital videophone answering device of claim 24, said submenus including options for manual or automatic delete, archive, backup, send to alternate device, recording of entire A/V messages and/or user selected segments, and other options including password protection, listing of saved recordings, save/erase, available record time, out of media storage alerts, undelete, and cut, truncate and paste features.

26. The digital videophone answering device of claim 25, wherein the user manages A/V recordings remotely, with or without a password requirement.

27. The digital videophone answering device of claim 25, wherein the user retrieves messages remotely via the internet or from an accessible storage device that is external to the DVR and digital videophone answering device.

28. The digital videophone answering device of claim 5, wherein one of the parameters is a call notification routing (CNR) function which notifies a designated phone or person of an incoming videophone call.

29. The digital videophone answering device of claim 5, wherein one of the parameters enables encryption of incoming or outgoing videophone messages.

30. A method of processing messages received by a digital videophone answering device using a digital video recorder (DVR), comprising:
storing audio and video (A/V) signals representing a videophone message received by the digital videophone answering device in a memory;
processing the stored A/V signals under the control of a processor in the DVR; and
displaying the received videophone message.

31. The method of claim 30, wherein the received videophone message is displayed on a display device, or, if a caller is not calling from a videophone, displayed as one of a stored personal identification picture of a known caller with either a voice or text message, displayed only as a text or data message, or emitted as only a voice message of the caller on a speaker of the display device.

32. The method of claim 31, wherein a user sends a command via a user interface device selected from one of a remote control device, execution keys and buttons provided on the DVR, and execution keys and buttons provided on the digital videophone answering device in order to display the videophone message.

33. In a system having a set top box with digital video recording capabilities, an apparatus for displaying audio and video messages received by the digital videophone answering device on a display device operatively connected to the set top box, comprising:
a memory for storing audio and video signals representing a videophone message received from a caller via a communication line in digital form; and
a processor for controlling a display of said videophone message based on received commands to access said memory so as to display said received videophone message on the display device.

34. The system of claim 33, wherein said memory and processor are contained within the set top box.

35. The system of claim 33, wherein said memory is external to the set top box and directly connected to the digital videophone answering device, and wherein the processor is contained within the set top box.

36. The system of claim 33, wherein the digital videophone answering device is configured to play customized out-going messages to designated incoming callers.

37. The system of claim 33, wherein the digital videophone answering device is configured is configured for handling data and text communications in additional to audio and video communications.

38. The system of claim 33, wherein the digital videophone answering device includes fast, slow and super-slow playback modes for videophone messages.
